(19) United States
(12) Patent Application Publication
(10) Pub. No.: US 2014/0306788 A1
(43) Pub. Date: Oct. 16, 2014

(54) FILTER COMPONENT

(71) Applicant: DENSO CORPORATION, Kariya-city (JP)

(72) Inventor: Kazuhiro UMETANI, Nagoya-city (JP)

(73) Assignee: DENSO CORPORATION, Kariya-city (JP)

(21) Appl. No.: 14/249,539

(22) Filed: Apr. 10, 2014

(30) Foreign Application Priority Data
Apr. 15, 2013 (JP) 2013-84937

(51) Int. Cl. H01F 27/28; H01F 27/24

(52) U.S. Cl. CPC H01F 27/2823; H01F 27/24; H01F 2027/2838
USPC 336/173

(57) ABSTRACT

A filter component is provided with a first winding wire, a second winding wire having a separate electric current supply from the first winding wire, and a third winding wire connected in series with the first winding wire. The first, second, and third winding wires are wound on a magnetic core. The magnetic core has a shape that allows a formation of a first magnetic path having the first and second winding wires interlinked therewith without having the third winding wire interlinked therewith, and a formation of a second magnetic path having the first and third winding wires interlinked therewith without having the second winding wire interlinked therewith. Further, the electric current flow directions of the first and second winding wires are opposite and the electric current flow directions of the first and third winding wires are the same.

### CROSS-REFERENCE TO RELATED APPLICATION

The present application is based on and claims the benefit of priority of Japanese Patent Application No. 2013-84937, filed on Apr. 15, 2013, the disclosure of which is incorporated herein by reference.

### TECHNICAL FIELD

The present disclosure relates to a filter component that provides a common mode choke coil function and a reactor function.

### BACKGROUND INFORMATION

In recent years, in response to demand for low-volume and lightweight electrical devices, power supply components are driven by high-frequency electric power. The high frequency drive of a power supply component may have (i) a fewer number of ripples riding on an input/output electric current and (ii) a smaller magnitude of electric voltage ripples on an input/output electric voltage. Therefore, the volume of a smoothing capacitor or a smoothing reactor, which is the controlling factor in terms of an overall volume of the power supply component, is reduced when the power supply component is driven by high frequency. In other words, the high frequency drive of the power supply component affects the volume and weight reduction of the power supply component.

The high frequency drive of the power supply component is made possible by the improved performance of semiconductors, which now allow high-speed switching of semiconductor devices. With high-speed switching, the switching loss caused in proportion to the switching frequency is reduced, thereby preventing the deterioration of device operation efficiency in the high frequency drive.

However, if high-speed switching is performed, high frequency common mode noise is easily generated, which is subject to a control of an Electro-Magnetic Interference (EMI) regulation. Therefore, it is necessary to add a common mode filter to remove common mode noise. Thus, the advantages of high frequency drive may be decreased, in terms of the volume reduction of the device and/or the weight reduction of the device.

An addition of the common mode filter may be described as an example in which a series connection of a reactor and a common mode choke coil is provided in a battery charge path that is disposed on an output side of the power supply component, and, in such arrangement, the reactor is used for reducing a transmission of a differential mode noise and the common mode choke coil is used for reducing a transmission of a common mode noise. See, for example, a patent document 1 (i.e., Japanese Patent Laid-Open No. 2009-213202). Such a power supply component has been used for a long time, regardless of the high speed switching. The power supply component having such a configuration is devised to prevent a deterioration of battery characteristics due to an in-flow of a harmonic noise flowing into the battery. That is, by an addition of the common mode choke coil, an outflow of the common mode noise flowing out from the power supply component is prevented.

However, the above-mentioned reactor and the above-mentioned common mode choke coil are formed on respectively-different magnetic cores. Therefore, for an addition of the common mode choke coil, a new core as well as a new winding need to be added, which leads to an increase of an overall volume of the device, since the addition of the common mode choke coil generally leads to an increase of dead space.

To prevent such an increase of dead space, a new technique is proposed in a patent document 2 (i.e., Japanese Patent No. 3236825), in which the reactor and the common mode choke coil are formed on one magnetic core, for example, instead of forming the reactor and the coil on respectively different (i.e., separate) magnetic cores. In the technique of the patent document 2, each of two outer legs in an EE type magnetic core has a winding. In such a structure, a magnetic path formed to be interlinked with both of winding wires that are wound around the outer legs serves as a common mode choke coil, and a magnetic path formed by one of the winding wires and a middle leg serves as a reactor. As a result, the reactor function and the common mode choke coil function are implemented on a single-body magnetic core.

However, since the number of turns provided on the reactor path and the number of turns (i.e., the number of turns regarding one of the two winding wires) provided on the path of the common mode choke coil need to be the same value in the technique disclosed in the patent document 2, such a limitation leads to a problematic situation in which independence between the number of turns of the reactor winding wires and the number of turns of the common mode choke coil winding wires cannot be achieved.

Generally, it is necessary to provide sufficient magnetic reluctance by using a gap etc. from a viewpoint of preventing the magnetic saturation by a direct electric current, in the reactor that generates a DC magnetic flux. Further, in order to achieve a desired inductance after increasing the magnetic reluctance, the number of turns of the reactor winding wires must be sufficiently large. Therefore, it is a common practice to have the greater number of turns on the reactor than on the common mode choke coil which is not required to have a gap due to its use for generating an AC magnetic flux only.

However, since the numbers of winding wires of both of the reactor and the common mode choke coil cannot be independently set in the technique of the patent document 2, two winding wires having the same number of turns have to be provided instead of providing one winding wire that has the number of turns required for forming a reactor. Therefore, while achieving the volume reduction by unifying the two cores for the reduction of the dead space, the volume of the winding wire may contrarily be increased.

Further, such an increase of the number of turns may bring about a bad influence on a noise removal capacity for removing a common mode noise, beside the increase of the volume of the device. This is because of a characteristic of the common mode noise which is transmittable by/through a parasitic capacitance between the winding wires even when the common mode choke coil is used to remove the common mode noise. For such a reason, in the common mode choke coil, the number of turns is limited to a certain value and a certain amount of gap is provided between two winding wires in many cases so that a large parasitic capacitance will not be formed between two winding wires.

However, as already mentioned above, the technique in the patent document 2 does not allow independent designs for the common mode choke coil and the reactor, i.e., the numbers of winding wires for the two components are always the same. Therefore, the common mode choke coil is designed to have the same number of turns as the reactor, whose number of turns has a greater value than the choke coil, thereby leading to an increase of the parasitic capacitance as a result, and also leading to the deterioration of the common mode noise removal capacity.

### SUMMARY

It is an object of the present disclosure to provide a filter component in which the common mode choke coil and the reactor are allowed to have respectively independent numbers of winding wires.

In an aspect of the present disclosure, the filter component includes a first winding wire, a second winding wire providing electric current to the first winding wire from a separate supply of electric current, and a third winding wire connected in series with the first winding wire. The filter component also includes a magnetic core having the first winding wire, the second winding wire, and the third winding wire wound around the magnetic core, and having a magnetic path of a magnetic flux that is caused by the electric current supplied to the first, second, and third winding wires formed in the magnetic core. A magnetic core shape provides, in an inside of the core, a first magnetic path which is a loop of the magnetic flux interlinked with the first winding wire and the second winding wire and not interlinked with the third winding wire, and a second magnetic path which is a loop of the magnetic flux interlinked with the first winding wire and the third winding wire and not interlinked with the second winding wire. A winding direction of the first winding wire on the magnetic core and a winding direction of the second winding wire on the magnetic core are configured such that an electric current flow direction in the first winding wire is opposite to an electric current flow direction in the second winding wire at an opening of the magnetic core, which is surrounded by the first magnetic path when the supply of the electric current flows from the first winding wire to the second winding wire. A winding direction of the first winding wire on the magnetic core and a winding direction of the third winding wire on the magnetic core are configured such that an electric current flow direction in the first winding wire is the same as an electric current flow direction in the third winding wire at the opening of the magnetic core, which is surrounded by the second magnetic path when the supply of the electric current flows to both of the first winding wire and the third winding wire that are connected in series.

The filter component configured in the above-described manner has the first magnetic path with which the first and second winding wires are interlinked, and the first winding and the second winding are wound around the magnetic core in opposite winding directions that set the flow directions of the electric currents in those winding wires to be opposite to each other at the opening of the magnetic core which is surrounded by the first magnetic path. That is, in other words, the first magnetic path serves as a well-known common mode choke coil.

Further, the filter component has the second magnetic path with which the first and third winding wires are interlinked, and the first winding and the third winding are wound around the magnetic core in the same winding direction that sets the electric current to flow in the same direction into the opening which is surrounded by the second magnetic path. That is, in other words, the second magnetic path serves as a reactor that has its winding wound around the magnetic core by the number being equal to a sum total of the number of turns of the first winding and the number of turns of the third winding.

By having the above-described configuration, the filter component has/provides a common mode choke coil function and a reactor function.

Further, the number of turns of the common mode choke coil is determined by the number of turns of the first winding and the number of turns of the second winding, and the number of turns of the reactor is determined by the number of turns of the first winding and the number of turns of the third winding. Therefore, the number of turns of the reactor can be changed by changing the number of turns of the third winding, without changing the number of turns of the first winding and the number of turns of the second winding, i.e., without changing the number of turns of the common mode choke coil.

Thus, according to the filter component described above, the common mode choke coil and the reactor in such filter component are allowed to have respectively different, i.e., independent, numbers of winding wires.

### BRIEF DESCRIPTION OF THE DRAWINGS

Objects, features, and advantages of the present disclosure will become more apparent from the following detailed description made with reference to the accompanying drawings, in which:

FIG. 1 is a plan view of a filter component in a first embodiment of the present disclosure;

FIG. 2 is a schematic diagram of an equivalent circuit that is equivalent to a circuit in FIG. 1;

FIG. 3 is a schematic diagram of a circuit having a same function as the circuit in FIG. 2;

FIG. 4 is a plan view of the filter component in a second embodiment of the present disclosure;

FIG. 5 is a schematic diagram of an equivalent circuit that is equivalent to a circuit in FIG. 4;

FIG. 6 is a plan view of the filter component in a third embodiment of the present disclosure;

FIG. 7 is a plan view of the filter component in a fourth embodiment of the present disclosure;

FIG. 8 is a plan view of the filter component in a fifth embodiment of the present disclosure;

FIG. 9 is a plan view of the filter component in a sixth embodiment of the present disclosure;

FIG. 10 is a plan view of the filter component in a seventh embodiment of the present disclosure;

FIG. 11 is a schematic diagram of an equivalent circuit that is equivalent to a circuit in FIG. 10;

FIG. 12 is a plan view of the filter component in an eighth embodiment of the present disclosure;

FIG. 13 is a schematic diagram of an equivalent circuit that is equivalent to a circuit in FIG. 12;

FIG. 14 is a plan view of the filter component in a ninth embodiment of the present disclosure;

FIG. 15 is a schematic diagram of an equivalent circuit that is equivalent to a circuit in FIG. 14;

FIG. 16 is a plan view of the filter component in a tenth embodiment of the present disclosure;

FIG. 17 is a plan view of the filter component in an eleventh embodiment of the present disclosure;

FIG. 18 is a schematic diagram of a first application example of the filter component;

FIG. 19 is a schematic diagram of a second application example of the filter component;

FIG. 20 is a schematic diagram of a third application example of the filter component;

FIG. 21 is a schematic diagram of a fourth application example of the filter component; and

FIG. 22 is a schematic diagram of an equivalent circuit to FIG. 21.

### DETAILED DESCRIPTION

### First Embodiment

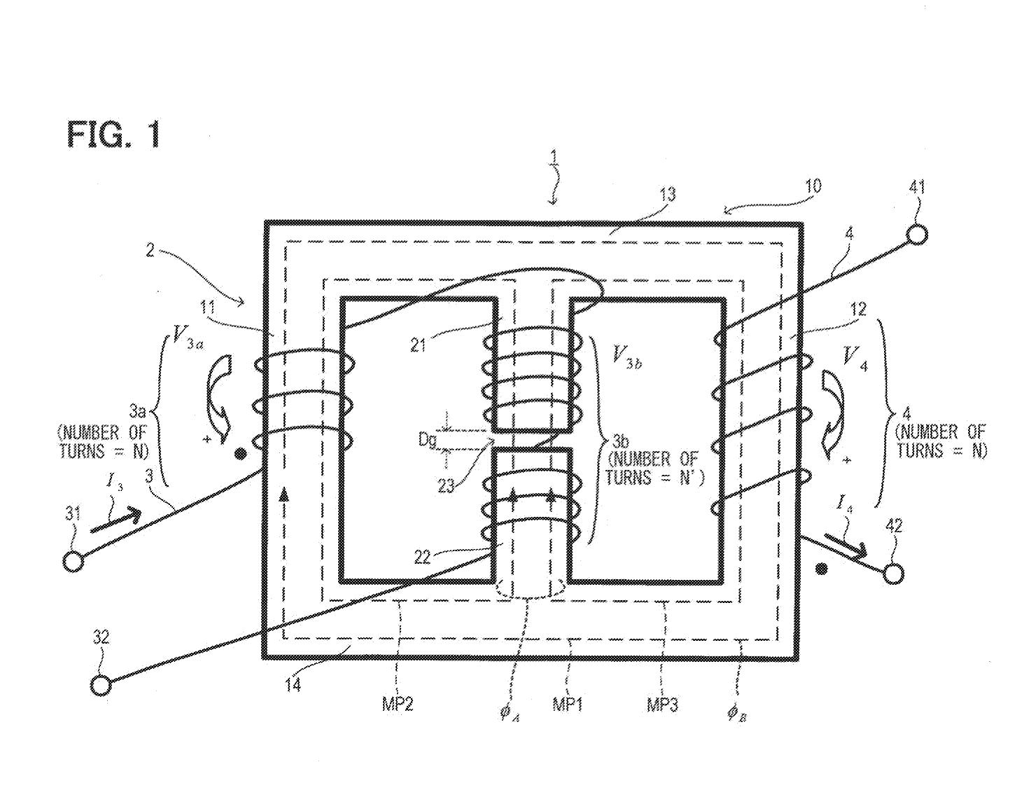

A first embodiment of the present disclosure is described with reference to the drawings. A filter component 1 of the present embodiment is provided with a magnetic core 2 and winding wires 3, 4 as shown in FIG. 1.

The magnetic core 2 includes a magnetic body 10 (henceforth a frame shape magnetic core member 10) formed in a rectangular frame shape, and magnetic bodies 21 and 22 (henceforth center members 21 and 22) arranged within the frame of the frame shape magnetic core member 10.

The frame shape magnetic core member 10 includes a left member 11, a right member 12, an upper core member 13, and a lower core member 14, that is, the left member 11 is a left side element of the rectangular frame shape of the magnetic core member 10, the right member 12 is a right side element of the rectangle, the upper core member 13 is an upside element of the rectangle and the lower core member 14 is a downside element of the rectangle.

The center member 21 extends from the upper core member 13 toward an inside of the rectangle of the magnetic core member 10, perpendicularly against the upper core member 13.

The center member 22 extends from the lower core member 14 toward an inside of the rectangle of the magnetic core member 10, perpendicularly against the lower core member 14. Further, the center member 22 faces the center member 21 with a predetermined amount of gap 23 (i.e., a clearance Dg) interposed therebetween. That is, the gap 23 is defined as/in a space between the member 21 and the member 22.

The winding wire 3 is wound around each of the left member 11 and the center members 21 and 22. The number of turns of the winding wire 3 that is wound around the left member 11 is equal to N (N is a positive integer), and the number of turns of the wire 3 wound around the center members 21 and 22 is equal to N′ (N′ is a positive integer).

In the following, a part of the winding wire 3 wound around the left member 11 is hereafter designated as a winding wire 3a, and a part of the winding wire 3 wound around the center members 21 and 22 is designated as a winding wire 3b.

The winding wire 3 is so wound around the core 10 that, when an electric current flows from one end 31 to other end 32 of the wire 3 (see an arrow I₃ in FIG. 1), the electric current flows initially into a part that is wound around the left member 11 and then flows into a part that is wound around the center members 21 and 22.

Further, when the electric current flows from the one end 31 to the other end 32 of the winding wire 3, the winding wire 3 is so wound around the left member 11 that the electric current in the wire 3 flows on an upper surface of the left member 11 from a right-hand side to a left-hand side in FIG. 1. Furthermore, when the electric current flows from the one end 31 to the other end 32 of the winding wire 3, the winding wire 3 is so wound around the center members 21 and 22 that the electric current in the wire 3 flows on an upper surface of the center members 21 and 22 from the left-hand side to the right-hand side in FIG. 1.

The winding 4 is wound around the right member 12. The number of turns of the winding wire 4 that is wound around the right member 12 is equal to N (i.e., N is a positive integer). The winding wire 4 is so wound around the core 10 that, when an electric current flows from one end 41 to other end 42 of the wire 4 (i.e., see an arrow I₄ in FIG. 1), the winding wire 4 is so wound around the right member 12 that the electric current flows on an upper surface of the right member 12 from a right-hand side to a left-hand side in FIG. 1.

Next, an operation principle of the filter component 1 configured in the above-described manner is described.

The magnetic flux in the filter component 1 is formed as an overlayed combination of a magnetic flux φ_{A} and a magnetic flux φ_{B} which are mutually-independent.

The magnetic flux φ_{B} is generated by the supply of the electric current to the winding wires 3 and 4, and forms a magnetic path MP1. The magnetic path MP1 is a closed magnetic circuit (i.e., a loop) which passes an inside of the core 2 through the left member 11, the right member 12, the upper core member 13, and the lower core member 14.

The magnetic flux φ_{B} is interlinked only with the winding wire 3a and the winding wire 4. Further, since a gap (i.e., the gap 23) which is formed between the center member 21 and the center member 22 does not exist on the magnetic path MP1, magnetic reluctance is small on the loop magnetic path (i.e., on the magnetic path MP1) of the magnetic flux φ_{B}.

Therefore, the magnetic flux φ_{B} and the winding wires 3a and 4 form a common mode choke coil. If Ampere's law is applied to the magnetic path MP1 formed by the magnetic flux φ_{B} a following equation (1) is obtained under a condition that magnetic reluctance can be ignored.

N×I₃−N×I₄=0 (Equation 1)

Then, an equation (2) is derived from the equation (1).

I₃=I₄ (Equation 2)

Induced voltages V₃ₐ, V₄ generated in the winding wires 3a and 4 while changing the magnetic flux φ_{B} and keeping the amount of the magnetic flux φ_{A} at a constant value are represented by a following equation (3).

$$- N \frac{d {φ}_{3 a}}{d t} = {V}_{3 a} = {V}_{4} \qquad ( Equation 3 )$$

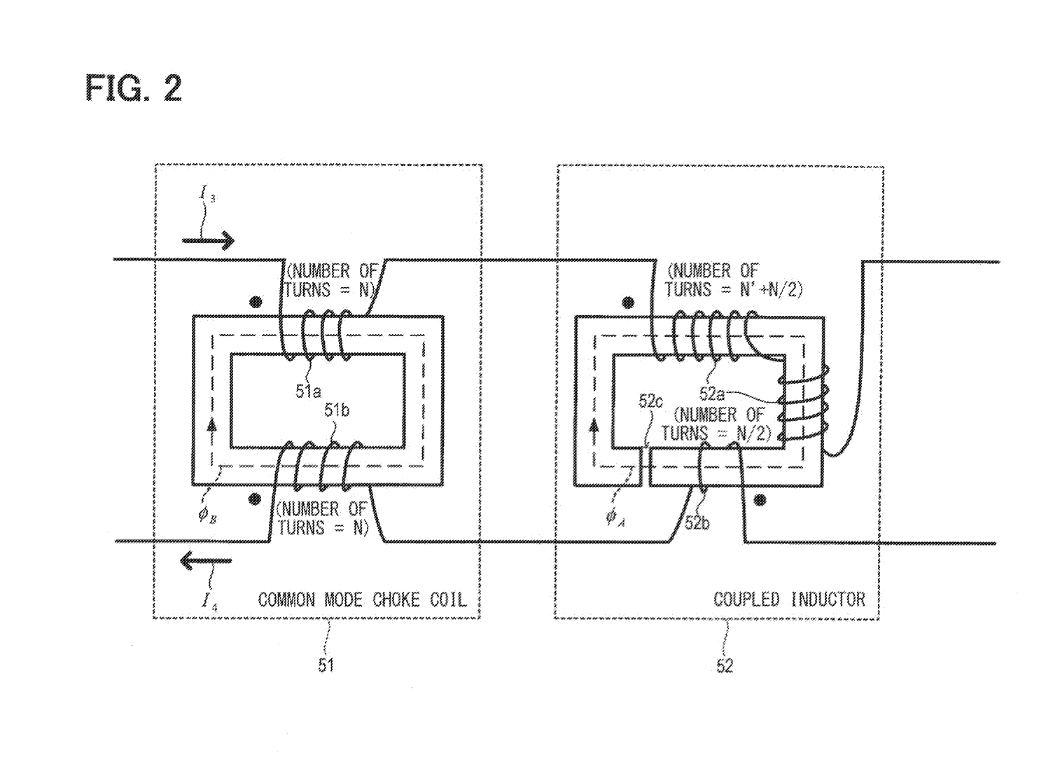

The features represented by the equations (1)-(3) are equivalent to a common mode choke coil 51 shown in FIG. 2. FIG. 2 shows an equivalent circuit of the filter component 1.

The common mode choke coil 51 is so structured that the magnetic flux φ_{B} is interlinked with a winding wire 51a whose number of turns is N, and is interlinked with a winding wire 51b whose number of turns is also N.

The magnetic flux φ_{A} is generated by the supply of the electric current to the winding wires 3, 4, and forms magnetic paths MP2 and MP3 as shown in FIG. 1.

The magnetic path MP2 is a closed loop of the magnetic path, which passes an inside of the left member 11, the center members 21 and 22, and left side portions of the upper core member 13 and the lower core member 14, i.e., the left side portions of the members 13, 14 relative to the members 21, 22.

The magnetic path MP3 is a closed loop of the magnetic path, which passes an inside of the core 2 through the right member 12, the center members 21 and 22, and right side portions of the upper core member 13 and the lower core member 14, i.e., the right side portions of the members 13, 14 relative to the members 21 and 22.

The magnetic flux φ_{A} is interlinked only with the winding wire 3a and the winding wire 3b on the magnetic path MP2, and is interlinked only with the winding wire 4 and the winding wire 3b on the magnetic path MP3.

Further, since the gap 23 exists on the magnetic paths MP2 and MP3, magnetic reluctance is large on the loop magnetic path (i.e., the magnetic paths MP2, MP3) of the magnetic flux φ_{A}.

Therefore, the magnetic flux φ_{A} and the winding wires 3a, 3b, 4 provide a reactor function (i.e., serve as a reactor).

If Ampere's law is applied to the magnetic paths MP2 and MP3 that are formed by the magnetic flux φ_{A}, an equation (4) is obtained. Here in the following equation, R is a value of the magnetic reluctance formed by the gap 23.

(N+N′)×I₃=R×φ_{A} (Equation 4)

The induced voltages V₃ₐ, V_{3b}, V₄ generated in the winding wires 3a, 3b and 4 when changing the magnetic flux φ_{A} and keeping the amount of the magnetic flux φ_{B} at a constant value are represented by following equations (5) and (6).

$$\begin{matrix}( \frac{N}{2} + {N}^{′} ) \frac{d {φ}_{A}}{d t} = {V}_{3 a} + {V}_{3 b} & ( Equation 5 ) \\ - \frac{N}{2} \frac{d {φ}_{A}}{d t} = {V}_{4} & ( Equation 6 )\end{matrix}$$

The features represented by the equations (4)-(6) are equivalent to a coupled inductor 52 shown in FIG. 2.

The coupled inductor 52 is so structured that the magnetic flux φ_{A} is interlinked with a winding wire 52a whose number of turns is (N′+N/2) and is interlinked with a winding wire 52b whose number of turns is (N/2), and the magnetic flux φ_{A} passes through a gap 52c that forms magnetic reluctance.

In this case, an equal amount of electric current flows to the two winding wires 52a and 52b of the coupled inductor 52 by the effect of the common mode choke coil. That is, even when a winding wire having an electric current I₄ flowing therein is replaced with a winding wire having an electric current I₃ flowing therein, a circuit function is unchanged.

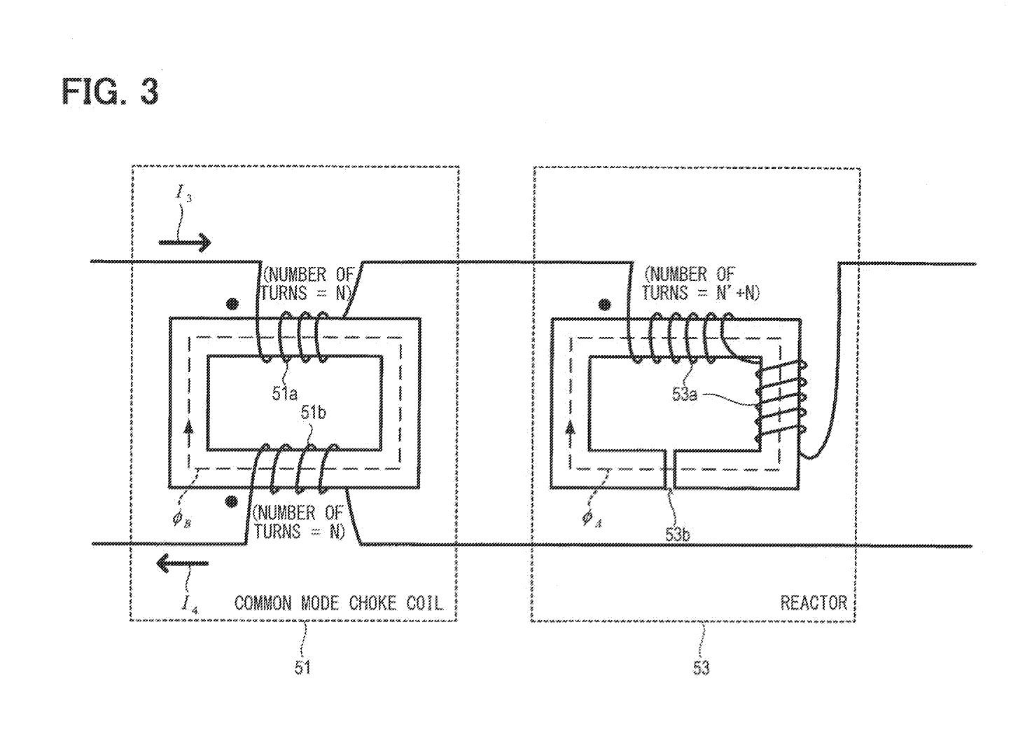

Therefore, as shown in FIG. 3, the coupled inductor 52 is replaceable with a reactor 53. FIG. 3 is a diagram of an equivalent circuit which has the same circuit function as the circuit in FIG. 2.

The reactor 53 is so structured that the magnetic flux φ_{A} is interlinked with a winding wire 53a whose number of turns is (N′+N), and the magnetic flux φ_{A} passes through a gap 53b which forms magnetic reluctance.

Further, the common mode choke coil 51 and the reactor 53 are connected in series. Therefore, the filter component 1 is provided with the function of the reactor and the common mode choke coil which are connected in series.

The filter component 1 configured in the above-described manner includes a first winding wire, a second winding wire providing electric current to the first winding wire from a separate supply of electric current, and a third winding wire connected in series with the first winding wire. The filter component also includes a magnetic core having the first winding wire, the second winding wire, and the third winding wire wound around the magnetic core, and having a magnetic path of a magnetic flux that is caused by the electric current supplied to the first, second, and third winding wires formed in the magnetic core. A magnetic core shape provides, in an inside of the core, a first magnetic path which is a loop of the magnetic flux interlinked with the first winding wire and the second winding wire and not interlinked with the third winding wire, and a second magnetic path which is a loop of the magnetic flux interlinked with the first winding wire and the third winding wire and not interlinked with the second winding wire. A winding direction of the first winding wire on the magnetic core and a winding direction of the second winding wire on the magnetic core are configured such that an electric current flow direction in the first winding wire is opposite to an electric current flow direction in the second winding wire at an opening of the magnetic core, which is surrounded by the first magnetic path when the supply of the electric current flows from the first winding wire to the second winding wire. A winding direction of the first winding wire on the magnetic core and a winding direction of the third winding wire on the magnetic core are configured such that an electric current flow direction in the first winding wire is the same as an electric current flow direction in the third winding wire at the opening of the magnetic core, which is surrounded by the second magnetic path when the supply of the electric current flows to both of the first winding wire and the third winding wire that are connected in series.

Thus, the filter component 1 is provided with the magnetic path MP1 with which the winding wire 3a and the winding wire 4 are interlinked, and the winding wire 3a and the winding wire 4 are so wound around the core 2 that the electric currents in the wire 3a and in the wire 4 flowing into the opening which is surrounded by the magnetic path MP1 have mutually-opposite flow directions at respective points of flowing into the opening. That is, the magnetic path MP1 serves as a well-known common mode choke coil.

Further, the filter component 1 is provided with the magnetic path MP2 with which the winding wire 3a and the winding wire 3b in a series connection are interlinked, and the winding wire 3a and the winding wire 3b are so wound around the core 2 that the electric currents in the wire 3a and in the wire 3b both flowing into the opening which is surrounded by the magnetic path MP2 have the same flow direction. That is, the magnetic path MP2 serves as a reactor which has the winding wire wound around the magnetic core by a number of turns which is equal to a sum total of the number of turns of the winding wire 3a and the number of turns of the winding wire 3b.

By devising the above winding structure, the filter component 1 has/provides a common mode choke coil function and a reactor function.

Further, the number of turns of the common mode choke coil is determined by the number of turns of the winding wire 3a and the winding wire 4, and the number of turns of the reactor is determined by the number of turns of the winding wire 3a and the winding wire 3b. Therefore, the number of turns of the reactor can be changed by changing the number of turns of the winding wire 3b, without changing the number of turns of the winding wire 3a and the winding wire 4, i.e., without changing the number of turns of the common mode choke coil.

Thus, according to the filter component 1, the common mode choke coil and the reactor which constitute the filter component 1 are allowed to have respectively different number of turns, i.e., the number of turns of the choke coil and the number of turns of the reactor can be mutually-independent.

Further, the number of turns of the winding wire 3a interlinked with the magnetic path MP1 is equal to the number of turns of the winding wire 4 interlinked with the magnetic path MP1. In such configuration, when a voltage of the same magnitude is applied to the winding wire 3a and to the winding wire 4, the same amount of the magnetic flux is generated by the winding wire 3a and by the winding wire 4. Therefore, when a differential mode noise is applied to the winding wire 3a and to the winding wire 4, the magnetic flux generated by having the differential mode noise applied to the winding wire 3a and the magnetic flux generated by having the differential mode noise applied to the winding wire 4 cancel each other. Therefore, the common mode choke coil in the filter component 1 can have an improved capability that reduces a transfer of the common mode noise, without reducing a transfer of the differential mode noise.

Further, the magnetic core 2 is formed to have a shape which allows, in an inside thereof, a formation of the magnetic path MP3 which is a loop magnetic flux in the magnetic core 2 interlinked with the winding wire 4 and the winding wire 3b and not interlinked with the winding wire 3a, in addition to having the magnetic path MP1 and the magnetic path MP2. Further, the magnetic core 2 has the winding wire 4 and the winding wire 3b so wound that the electric currents in the wire 4 and in the wire 3b have the same flow direction when flowing into the opening surrounded by the magnetic path MP3.

That is, the magnetic path MP3 serves as a reactor whose number of turns on the magnetic core is a sum total of the number of turns of the winding wire 4 and the number of turns of the winding wire 3b.

Thereby, the filter component 1 has an improved capability for reducing a transfer of a differential mode noise, since the reactor formed by the magnetic path MP3 is provided in addition to the reactor formed by the magnetic path MP2. The reactor 53 shown as a single reactor in FIG. 3 in this case represents a functionally-equivalent circuit of a combination of these two reactors.

The magnetic reluctance of the magnetic paths MP2 and MP3 is larger than the magnetic reluctance of the magnetic path MP1, since the gap 23 exists on the magnetic paths MP2 and MP3. Thereby, the magnetic saturation by a direct electric current is controlled and reduced in the reactor formed by the magnetic paths MP2 and MP3.

In the embodiment described above, the winding wire 3a is a first winding of the present disclosure, the winding wire 4 is a second winding of the present disclosure, the winding wire 3b is a third winding of the present disclosure, the magnetic core 2 is a magnetic core of the present disclosure, the magnetic path MP1 is a first magnetic path of the present disclosure, the magnetic path MP2 is a second magnetic path of the present disclosure, and the magnetic path MP3 is a third magnetic path of the present disclosure.

Further, the left member 11 is a first core member of the present disclosure, the right member 12 is a second core member of the present disclosure, the center members 21 and 22 are a third core member of the present disclosure, the upper core member 13 is a first connecting member of the present disclosure, and the lower core member 14 is a second connecting member of the present disclosure.

### Second Embodiment

The second embodiment of the present disclosure is described with reference to the drawings. Description of the second embodiment focuses on a difference from the first embodiment.

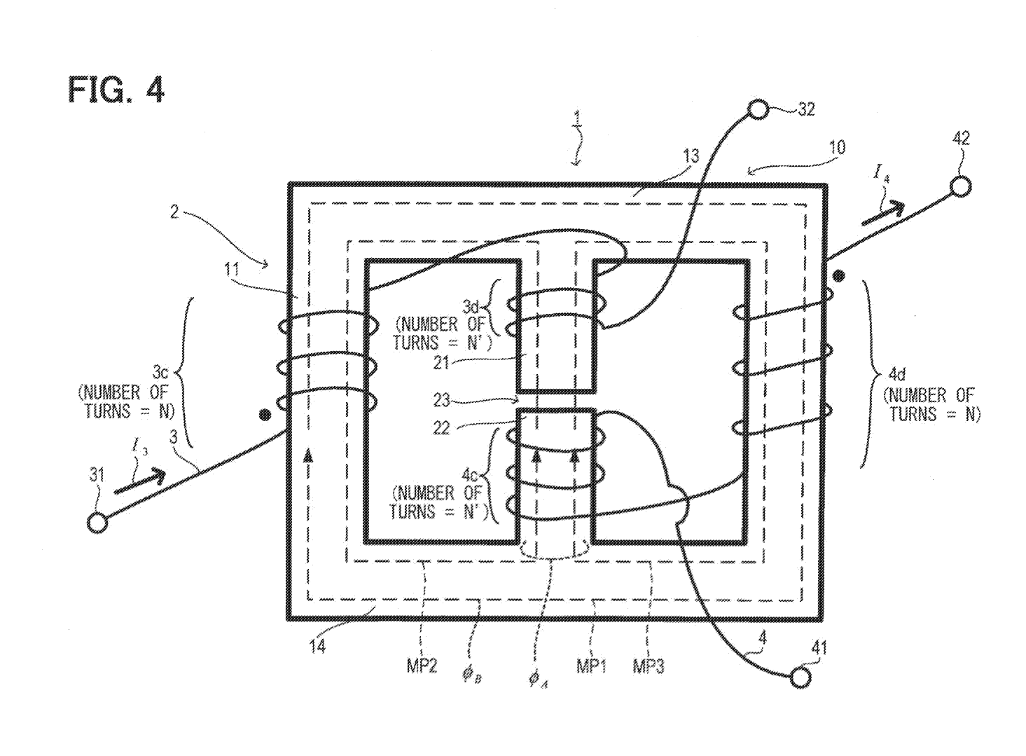

The filter component 1 of the second embodiment is provided with the magnetic core 2 and the winding wires 3 and 4 as shown in FIG. 4.

The winding wire 3 is wound around each of the left member 11 and the center member 21. The number of turns of the winding wire 3 on the left member 11 is equal to N (N is a positive integer) and the number of turns of the winding wire 3 on the center member 21 is equal to N′ (N′ is a positive integer).

In the following, a part of the winding wire 3 which is wound around the left member 11 is hereafter designated as a winding wire 3c and a part of the winding wire 3 which is wound around the center member 21 is hereafter designated as a winding wire 3d.

The winding wire 3 is so wound around the core 10 that, when an electric current flows from the one end 31 to the other end 32 of the wire 3 (see an arrow I₃ in FIG. 4), the electric current flows initially into a part that is wound around the left member 11 and then flows into a part that is wound around the center member 21.

Further, when the electric current I₃ flows from the one end 31 to the other end 32 of the winding wire 3, the winding wire 3 is so wound around the left member 11 that the electric current flows on the upper surface of the left member 11 from a right-hand side to a left-hand side (i.e., clockwise) in FIG. 4. Furthermore, when the electric current flows from the one end 31 to the other end 32 of the winding wire 3, the winding wire 3 is so wound around the center member 21 that the electric current flows on the upper surface of the center member 21 from the left-hand side to the right-hand side in FIG. 4. That is, the electric current flows clockwise in a part of the wire 3 which is placed on the upper surface of the left member 11. In other words, the winding direction of the winding wire 3 is so configured on the left member 11 in this case.

The winding wire 4 is wound around each of the right member 12 and the center member 22. The number of turns of the winding wire 4 on the right member 12 is equal to N (N is a positive integer) and the number of turns of the winding wire 4 on the center member 22 is equal to N′ (N′ is a positive integer).

In the following, a part of the winding wire 4 which is wound around the right member 12 is hereafter designated as a winding wire 4d and a part of the winding wire 4 which is wound around the center member 22 is hereafter designated as winding wire 4c.

The winding wire 4 is so wound around the core 10 that, when the electric current flows from the one end 41 to the other end 42 of the wire 4 (see an arrow I₄ in FIG. 4), the electric current flows initially into a part that is wound around the center member 22 and then flows into a part that is wound around the right member 12.

Further, when the electric current I₄ flows from the one end 41 to the other end 42 of the winding wire 4, the winding wire 4 is so wound around the center member 22 that the electric current flows on the upper surface of the center member 22 from a left-hand side to a right-hand side (i.e., counterclockwise) in FIG. 4. Furthermore, when the electric current flows from the one end 41 to the other end 42 of the winding wire 4, the winding wire 4 is so wound around the right member 12 that the electric current flows on the upper surface of the right member 12 from the right-hand side to the left-hand side in FIG. 4.

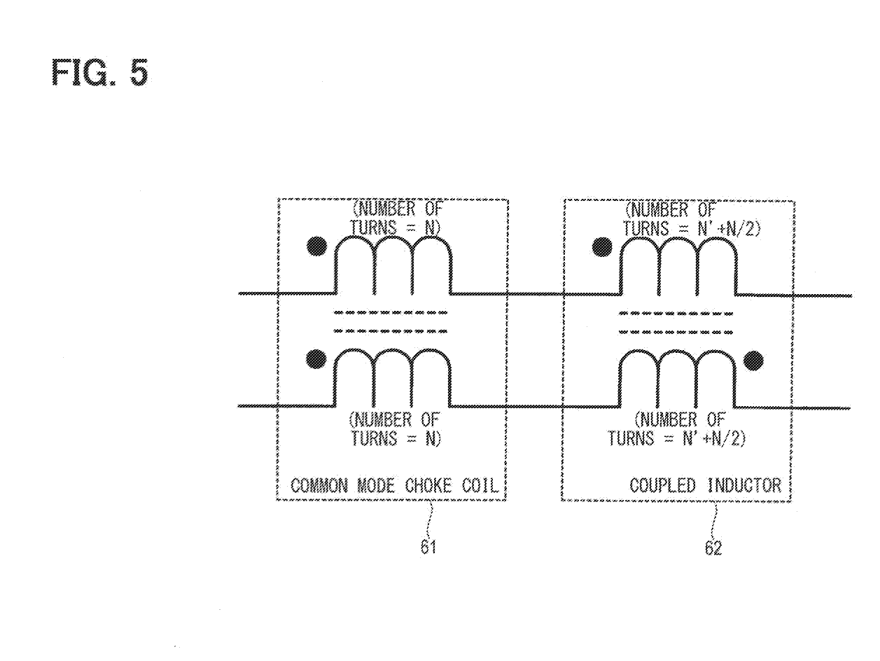

The filter component 1 configured in the above-described manner serves as an equivalent circuit of a series connection of a common mode choke coil 61 whose number of turns is N and a coupled inductor 62 whose number of turns is (N′+N/2), as shown in FIG. 5.

Further, the filter component 1 configured in the above-described manner includes the winding wire 3c provided as a winding of wire. The winding wire 4d is provided as a winding of wire, to which a separate supply of an electric current is provided separately from the supply of the electric current to the winding wire 3c. The winding wire 3d is provided as a winding of wire, which is connected in series with the winding wire 3c. The winding wire 4c is provided as a winding of wire, which is connected in series to the winding wire 4d. The winding wire 3c, the winding wire 4d, the winding wire 3d, and the winding wire 4c are wound on the magnetic core 2, and a magnetic path for flowing a magnetic flux that is caused by the electric currents supplied to the winding wires 3c, 4d, 3d, 4c flows through the magnetic core 2.

Further, the magnetic core 2 has a shape that allows, in an inside thereof, a formation of the first magnetic path MP1 which is a loop of the magnetic flux interlinked with the winding wire 3c and the winding wire 4d and not interlinked with the winding wire 3d and the winding wire 4c and a formation of the second magnetic path MP2 which is a loop of the magnetic flux interlinked with the winding wire 3c, the winding wire 4c and the winding wire 3d and not interlinked with the winding wire 4d and a formation of a third magnetic path MP3 which is a loop of the magnetic flux interlinked with the winding wire 4c, the winding wire 3d and the winding wire 4d and not interlinked with the winding wire 3c.

Further, a winding direction of the winding wire 3c on the magnetic core 2 and a winding direction of the winding wire 4d on the magnetic core 2 are so configured that a flow direction of the electric current in the winding wire 3c is made to be opposite to a flow direction of the electric current in the winding wire 4d when the electric currents in the wires 3c and 4d flow into an opening of the magnetic core 2 which is surrounded by the first magnetic path MP1 according to the supply of the electric current flowing from the winding wire 3c to the winding wire 4d. Also, a winding direction of the winding wire 3c on the magnetic path MP2 and a winding direction of the winding wire 3d on the magnetic path MP2 are so configured that a flow direction of the electric current in the winding wire 3c is made to be the same as a flow direction of the electric current in the winding wire 3d when the electric currents in the wires 3c and 3d flow into the opening of the magnetic core 2 which is surrounded by the second magnetic path MP2 according to the supply of the electric current flowing to both of the winding wire 3c and the winding wire 3d that are in a series connection. Similarly, a winding direction of the winding wire 4c on the magnetic path MP3 and a winding direction of the winding wire 4d on the magnetic path MP3 are so configured that a flow direction of the electric current in the winding wire 4c is made to be the same as a flow direction of the electric current in the winding wire 4d when the electric currents in the wires 4c and 4d flow into the opening of the magnetic core 2 which is surrounded by the second magnetic path MP3 according to the supply of the electric current flowing to both of the winding wire 4c and the winding wire 4d that are in a series connection.

Thus, the filter component 1 is provided with the magnetic path MP1 with which the winding wire 3c and the winding wire 4d are interlinked, and the winding wire 3c and the winding wire 4d are so wound around the core 2 that the electric currents in the wire 3c and in the wire 4d flowing into the opening which is surrounded by the magnetic path MP1 have mutually-opposite flow directions. That is, the magnetic path MP1 serves as a well-known common mode choke coil.

Further, the filter component 1 is provided with the magnetic path MP2 with which the winding wire 3c, the winding wire 4c and the winding wire 3d that are in a series connection are interlinked, and the winding wire 3c and the winding wire 3d are so wound around the core 2 that the electric currents in the wire 3c and in the wire 3d both flowing into the opening which is surrounded by the magnetic path MP2 have the same flow direction. In addition, the winding wire 4c is so wound around the core 2 that the electric current in the wire 4c flowing into the opening which is surrounded by the magnetic path MP2 has the same flow direction as the electric currents in the wire 3c and in the wire 3d. Therefore, the magnetic path MP2 serves as a coupled inductor which has the winding wire wound around the magnetic core by a number of turns which is equal to a sum total of the number of turns of the winding wire 3c, the number of turns of the winding wire 3d and the number of turns of the winding wire 4c.

Similarly, the filter component 1 is provided with the magnetic path MP3 with which the winding wires 4c, 3d and 4d in a series connection are interlinked, and the winding wires 4c and 4d are so wound around the core 2 that the electric currents in the wires 4c, 4d flowing into the opening surrounded by the magnetic path MP3 flow in the same direction. In addition, the winding wire 3d is so wound that the electric current in the wire 3d flowing into the opening surrounded by the magnetic path MP3 flows in the same direction as the electric currents in the winding wires 4c, 4d. Therefore, the magnetic path MP3 serves as a coupled inductor which has the winding wire wound around the magnetic core by a number of turns which is equal to a sum total of the number of turns of the winding wire 4c, the number of turns of the winding wire 3d and the number of turns of the winding wire 4d.

The coupled inductor 62 shown as a single coupled inductor in FIG. 5 in this case represents a functionally-equivalent circuit of the coupled inductor made by the magnetic path MP2 and the magnetic path MP3.

In other words, a series-connected winding wires 3c and 3d (i.e., the winding wire 3) serve partially as the common mode choke coil 61 and partially as the coupled inductor 62, and a series-connected winding wires 4c and 4d (i.e., the winding wire 4) also serve partially as the common mode choke coil 61 and partially as the coupled inductor 62. Therefore, based on a fact that both of the winding wire 3 and the winding wire 4 serve as a common mode choke coil and a coupled inductor, the filter component 1 has a symmetric circuit configuration of the common mode choke coil and the coupled inductor among (i.e., in terms of use of) the winding wire 3 and the winding wire 4. In such manner, induced voltages asymmetrically generated among the winding wire 3 and the winding wire 4, which causes a common mode electric current to be easily generated, is controlled and/or reduced.

Further, since the number of turns of the winding wire 3d is equal to the number of turns of the winding wire 4c, the filter component 1 has a symmetrical configuration among two parts of the coupled inductor 62, i.e., for the winding wire 3 part and for the winding wire 4 part of the coupled inductor 62. In such manner, induced voltages asymmetrically generated among the winding wire 3 and the winding wire 4, which causes a common mode electric current to be easily generated, is further controlled and/or reduced.

In the embodiment described above, the winding wire 3c is a first winding of the present disclosure, the winding wire 4d is a second winding of the present disclosure, the winding wire 3d is a third winding of the present disclosure, and the winding wire 4c is a fourth winding of the present disclosure.

Further, the center members 21 and 22 are a fourth winding member of the present disclosure, the upper core member 13 is a third connecting member of the present disclosure, and the lower core member 14 is a fourth connecting member of the present disclosure.

### Third Embodiment

The third embodiment of the present disclosure is described with reference to the drawings. Description of the third embodiment focuses on a difference of the third embodiment from the first embodiment.

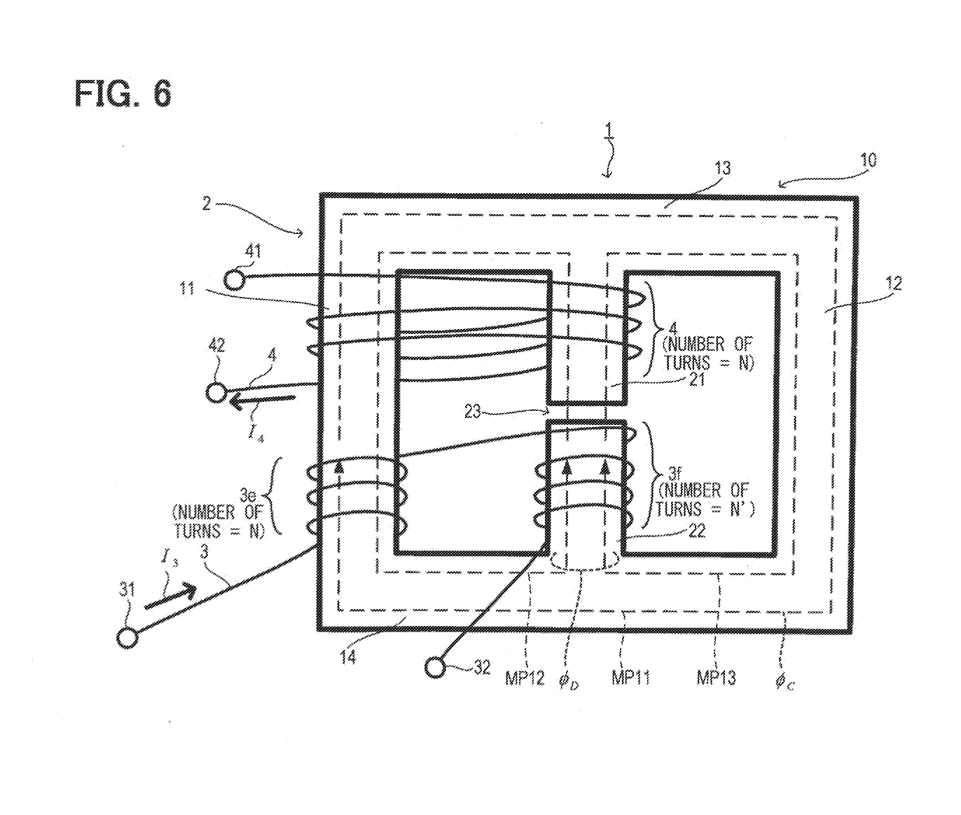

The filter component 1 of the third embodiment is provided with the magnetic core 2 and the winding wires 3 and 4 as shown in FIG. 6.

The winding wire 3 is wound around each of the left member 11 and the center member 22. The number of turns of the winding wire 3 on the left member 11 is equal to N (N is a positive integer), and the number of turns of the center member 22 is equal to N′ (N′ is a positive integer).

A part of the winding wire 3 that is wound around the left member 11 is hereafter designated as a winding wire 3e, and a part of the wire 3 that is wound around the center member 22 is hereafter designated as a winding wire 3f.

Further, the winding wire 3 is so wound that, when an electric current flows from the one end 31 to the other end 32 of the wire 3 (see the arrow I₃ in FIG. 6), the electric current flows initially into the part that is wound around the left member 11, and then flows into the part that is wound around the center member 22.

Further, when the electric current I₃ flows from the one end 31 to the other end 32 of the winding wire 3, the winding wire 3 is so wound around the left member 11 that the electric current flows on the upper surface of the left member 11 from the right-hand side to the left-hand side (i.e., clockwise) in FIG. 6. Further, when the electric current flows from the one end 31 to the other end 32 of the winding wire 3, the winding wire 3 is so wound around the center member 22 that the electric current flows on the upper surface of the center member 22 from the left-hand side to the right-hand side in FIG. 6.

The winding wire 4 is wound around the magnetic core 2 so that both of the left member 11 and the center member 21 are circled in the loop of the wire 4. The number of turns of the winding wire 4 is equal to N. Further, the winding wire 4 is so wound that, when an electric current flows from the one end 41 to the other end 42 of the wire 4 (see the arrow I₄ in FIG. 6), the electric current flows on the upper surface of the left member 11 and the center member 21 from the left-hand side to the right-hand side (i.e., counterclockwise) in FIG. 6.

The magnetic flux in the filter component 1 is formed as a superposition of a magnetic flux φ_{C} and a magnetic flux φ_{D} which are mutually-independent.

The magnetic flux φ_{C} is generated by the supply of the electric current to the winding wires 3 and 4, and forms a magnetic path MP11. The magnetic path MP11 is a closed magnetic circuit (i.e., a loop) which passes an inside of the core 2 through the left member 11, the right member 12, the upper core member 13, and the lower core member 14.

The magnetic flux φ_{C} is interlinked only with the winding wire 3e and the winding wire 4. Further, since the magnetic path MP11 has no gap (e.g., a gap like the gap 23 which is formed between the center member 21 and the center member 22), magnetic reluctance is small on the loop of the magnetic path (i.e., on the magnetic path MP11) of the magnetic flux φ_{C}.

Therefore, the magnetic flux φ_{C} and the winding wires 3e and 4 form a common mode choke coil.

The magnetic flux φ_{D} is generated by the supply of the electric current to the winding wires 3 and 4, and forms the magnetic paths MP12 and MP13.

The magnetic path MP12 is a closed loop of the magnetic path that passes an inside of the core 2 through the left member 11, the center members 21 and 22, and left halves (i.e., left parts) of the upper core member 13 and the lower core member 14 relative to the members 21, 22.

The magnetic path MP13 is a closed loop of the magnetic path that passes an inside of the core 2 through the right member 12, the center members 21 and 22, and right halves (i.e., right parts) of the upper core member 13 and the lower core member 14 relative to the members 21, 22.

The magnetic flux φ_{D} is interlinked only with the winding wire 3e and the winding wire 3f on the magnetic path MP12, and is interlinked only with the winding wire 4 and the winding wire 3f on the magnetic path MP13.

Further, since the gap 23 exists on the magnetic paths MP12 and MP13, magnetic reluctance is large on the loop magnetic path (i.e., the magnetic paths MP12, MP13) of the magnetic flux φ_{D}.

Therefore, the magnetic flux φ_{D} and the winding wires 3e, 3f, and 4 provide a reactor function.

In the filter component 1 configured in the above-described manner, the magnetic core 2 at least includes a first core part that is a part of the core 2 on which the winding wire (i.e., the wires 3 and 4) is wound and a second core part that is a part of the core 2 on which no winding wire is wound. That is, the first core part includes the left member 11 and the center members 21 and 22, and the second core part includes the upper core member 13, the lower core member 14, and the right member 12. Further, the second core part circles around a periphery of the first core part, except for one section. In such manner, the second core part having no winding wire wound thereon functions as a magnetic shield which prevents a leak of the magnetic flux leaking from the first core part, thereby preventing an electromagnetic interference between the filter component 1 and a circuit disposed at the proximity of the filter component 1.

In the embodiment described above, the winding wire 3e is a first winding of the present disclosure, the winding wire 4 is a second winding of the present disclosure, the winding wire 3f is a third winding of the present disclosure, the magnetic path MP11 is a first magnetic path of the present disclosure, the magnetic path MP12 is a second magnetic path of the present disclosure, and the magnetic path MP13 is a third magnetic path of the present disclosure.

### Fourth Embodiment

The fourth embodiment of the present disclosure is described with reference to the drawings. The fourth embodiment focuses on a difference from the first embodiment.

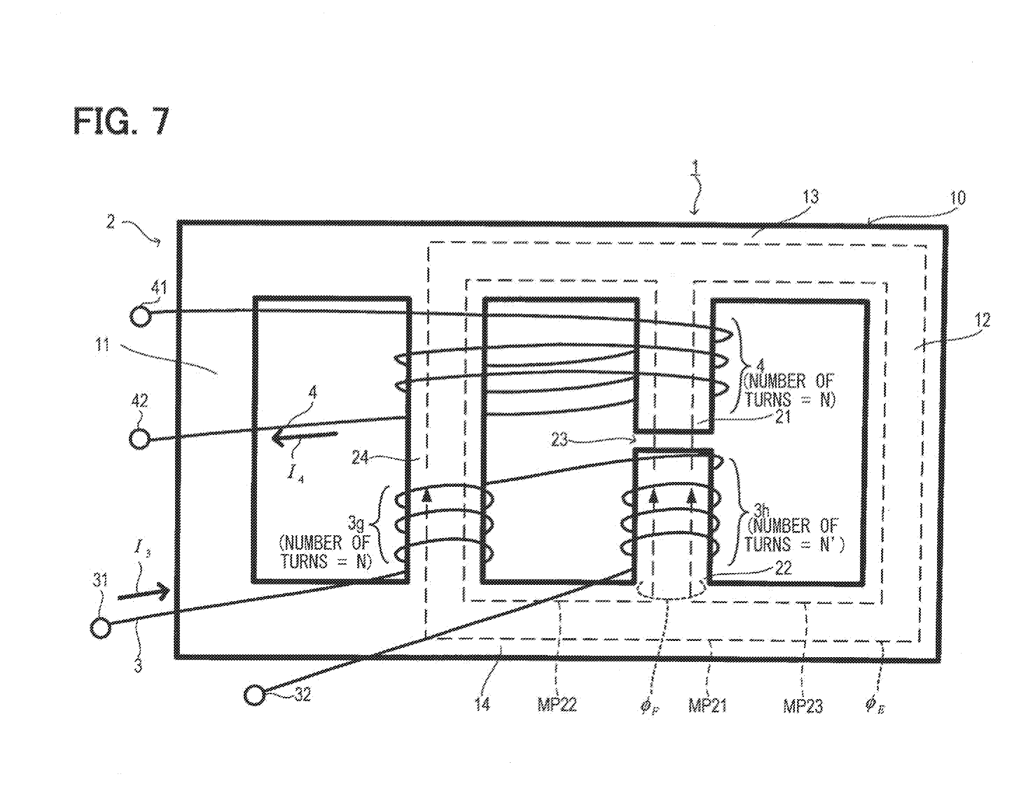

The filter component 1 of the fourth embodiment is provided with the magnetic core 2 and the winding wires 3 and 4 as shown in FIG. 7.

The magnetic core 2 includes the frame shape magnetic core member 10, the center members 21 and 22, and a center member 24.

The center member 24 projects perpendicularly from the upper core member 13 at a position between the left member 11 and the center members 21 and 22, toward an inside of the frame shape of the magnetic core member 10, which results in a bridging shape between the upper core member 13 and the lower core member 14.

The winding wire 3 is wound around each of the center member 24 and the center member 22. The number of turns of the winding wire 3 on the center member 24 is equal to N (N is a positive integer), and the number of turns of the center member 22 is equal to N′ (N′ is a positive integer).

A part of the winding wire 3 that is wound around the center member 24 is hereafter designated as a winding wire 3g, and a part of the wire 3 that is wound around the center member 22 is hereafter designated as a winding wire 3h.

Further, the winding wire 3 is so wound that, when an electric current flows from the one end 31 to the other end 32 of the wire 3 (see the arrow I₃ in FIG. 7), the electric current flows initially into the part that is wound around the center member 24, and then flows into the part that is wound around the center member 22.

Further, when the electric current I₃ flows from the one end 31 to the other end 32 of the winding wire 3, the winding wire 3 is so wound around the center member 24 that the electric current flows on the upper surface of the center member 24 from the right-hand side to the left-hand side in FIG. 7. Further, when the electric current flows from the one end 31 to the other end 32 of the winding wire 3, the winding wire 3 is so wound around the center member 22 that the electric current flows on the upper surface of the center member 22 from the left-hand side to the right-hand side in FIG. 7.

The winding wire 4 is wound around the magnetic core 2 so that both of the center member 24 and the center member 21 are circled in the loop of the wire 4. The number of turns of the winding wire 4 is equal to N. Further, the winding wire 4 is so wound that, when an electric current flows from the one end 41 to the other end 42 of the wire 4 (see the arrow I₄ in FIG. 7), the electric current flows on the upper surface of the center member 24 and the center member 21 from the left-hand side to the right-hand side in FIG. 7.

The magnetic flux in the filter component 1 is formed as a superposition of a magnetic flux φ_{E} and a magnetic flux φ_{F} which are mutually-independent.

The magnetic flux φ_{E} is generated by the supply of the electric current to the winding wires 3 and 4, and forms a magnetic path MP21. The magnetic path MP21 is a closed magnetic circuit (i.e., a loop) which passes an inside of the core 2 through the center member 24, the right member 12, and right parts of the upper core member 13 and the lower core member 14 relative to the center member 24.

The magnetic flux φ_{E} is interlinked only with the winding wire 3g and the winding wire 4. Further, since the magnetic path MP21 has no gap (e.g., a gap like the gap 23 which is formed between the center member 21 and the center member 22), magnetic reluctance is small on the loop of the magnetic path (i.e., on the magnetic path MP21) of the magnetic flux φ_{E}.

Therefore, the magnetic flux φ_{E} and the winding wires 3g and 4 form a common mode choke coil.

The magnetic flux φ_{F} is generated by the supply of the electric current to the winding wires 3 and 4, and forms magnetic paths MP22 and MP23.

The magnetic path MP22 is a closed loop of the magnetic path that passes an inside of the core 2 through (i) the center member 24, (ii) the center members 21 and 22, and (iii) middle parts of the upper core member 13 and the lower core member 14 which are positioned between the member 24 and the members 21, 22.

The magnetic path MP23 is a closed loop of the magnetic path that passes an inside of the core 2 through the right member 12, the center members 21 and 22, and right parts of the upper core member 13 and the lower core member 14 relative to the members 21, 22.

The magnetic flux φ_{F} is interlinked only with the winding wire 3g and the winding wire 3h on the magnetic path MP22, and is interlinked only with the winding wire 4 and the winding wire 3h on the magnetic path MP23.

Further, since the gap 23 exists on the magnetic paths MP22 and MP23, magnetic reluctance is large on the loop magnetic path of the magnetic flux φ_{F} (i.e., on the magnetic paths MP22, MP23).

Therefore, the magnetic flux φ_{F} and the winding wires 3g, 3h, and 4 provide a reactor function.

In the filter component 1 configured in the above-described manner, the magnetic core 2 at least includes the first core part that is a part of the core 2 on which the winding wire (i.e., the wires 3 and 4) is wound and the second core part that is a part of the core 2 on which no winding wire is wound at all. That is, the first core part includes the center member 24 and the center members 21 and 22, and the second core part includes the left member 11, the upper core member 13, the lower core member 14, and the right member 12. Further, the second core part circles around a periphery of the first core part. In such manner, the second core part having no winding wire wound thereon functions as a magnetic shield which prevents a leak of the magnetic flux leaking from the first core part, thereby preventing an electromagnetic interference between the filter component 1 and a circuit arranged at the proximity of the filter component 1.

In the embodiment described above, the winding wire 3g is a first winding of the present disclosure, the winding wire 4 is a second winding of the present disclosure, the winding wire 3h is a third winding of the present disclosure, the magnetic path MP21 is a first magnetic path of the present disclosure, the magnetic path MP22 is a second magnetic path of the present disclosure, and the magnetic path MP23 is a third magnetic path of the present disclosure.

### Fifth Embodiment

The fifth embodiment of the present disclosure is described with reference to the drawings. The fifth embodiment focuses on a difference from the third embodiment.

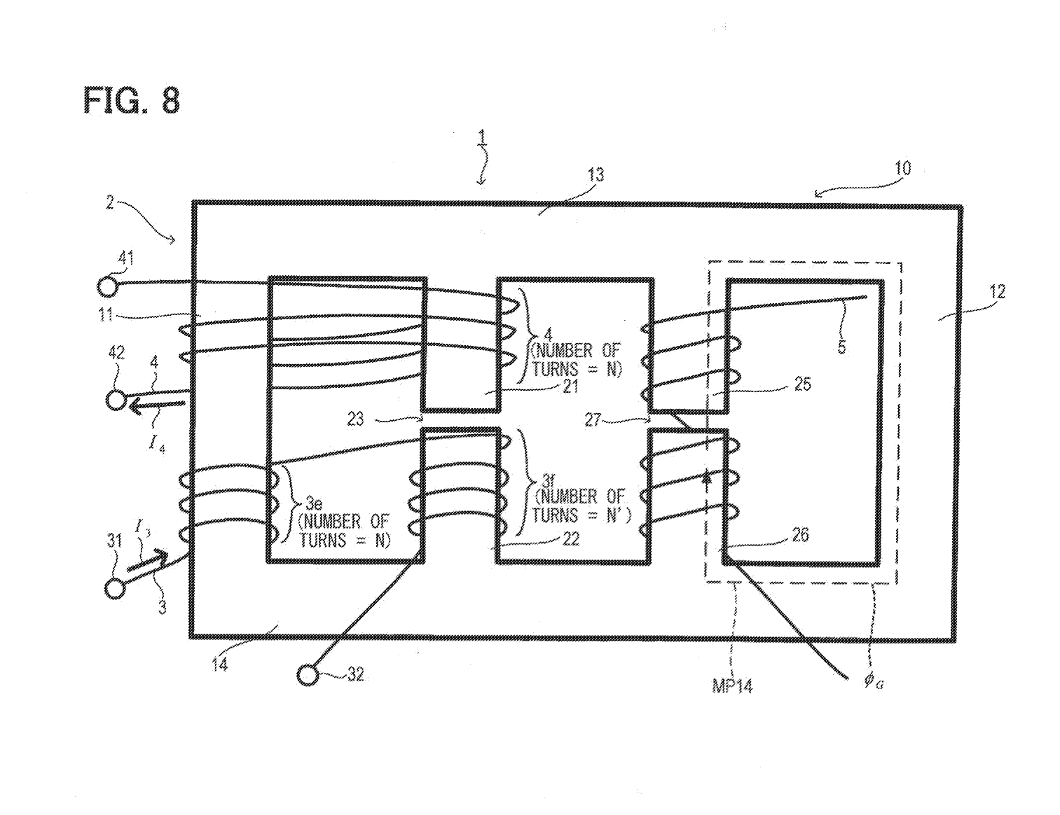

The filter component 1 of the fifth embodiment is provided with the magnetic core 2, the winding wires 3, 4, and a winding wire 5 as shown in FIG. 8.

The magnetic core 2 includes the frame shape magnetic core member 10, the center members 21 and 22, and center members 25 and 26.

The center member 25 projects perpendicularly from the upper core member 13 at a position between the right member 12 and the center members 21 and 22, toward an inside of the frame shape of the magnetic core member 10.

The center member 26 projects perpendicularly from the lower core member 14 at a position between the right member 12 and the center members 21 and 22, toward an inside of the frame shape of the magnetic core member 10. Further, the center member 26 faces the center member 25 with a predetermined amount of gap 27 interposed therebetween. That is, the gap 27 is defined in a space between the member 25 and the member 26.

The winding wire 5 is wound around each of the center members 25 and 26. Further, a magnetic flux φ_{G} generated by the supply of the electric current to the winding wire 5 forms a magnetic path MP14. The magnetic path MP14 is a closed magnetic circuit (i.e., a loop) which passes an inside of the core 2 through the center members 25 and 26, the right member 12, and right parts of the upper core member 13 and the lower core member 14 relative to the members 25, 26. The magnetic path MP14 passes through the gap 27 which forms magnetic reluctance. Therefore, the magnetic flux φ_{G} and the winding wire 5 provide a reactor function.

The magnetic flux in magnetic parts tends to flow into a path which has no winding wire wound thereon and has a lower magnetic reluctance preferentially. Therefore, the magnetic flux φ_{G} generated by the supply of the electric current to the winding wire 5 passes the right member 12, instead of passing the center members 21 and 22 and the left member 11. Thus, an electromagnetic interference between the magnetic parts having the winding wire 5 and the magnetic parts having the winding wires 3 and 4 is prevented.

### Sixth Embodiment

The sixth embodiment of the present disclosure is described with reference to the drawings. The sixth embodiment focuses on a difference from the third embodiment.

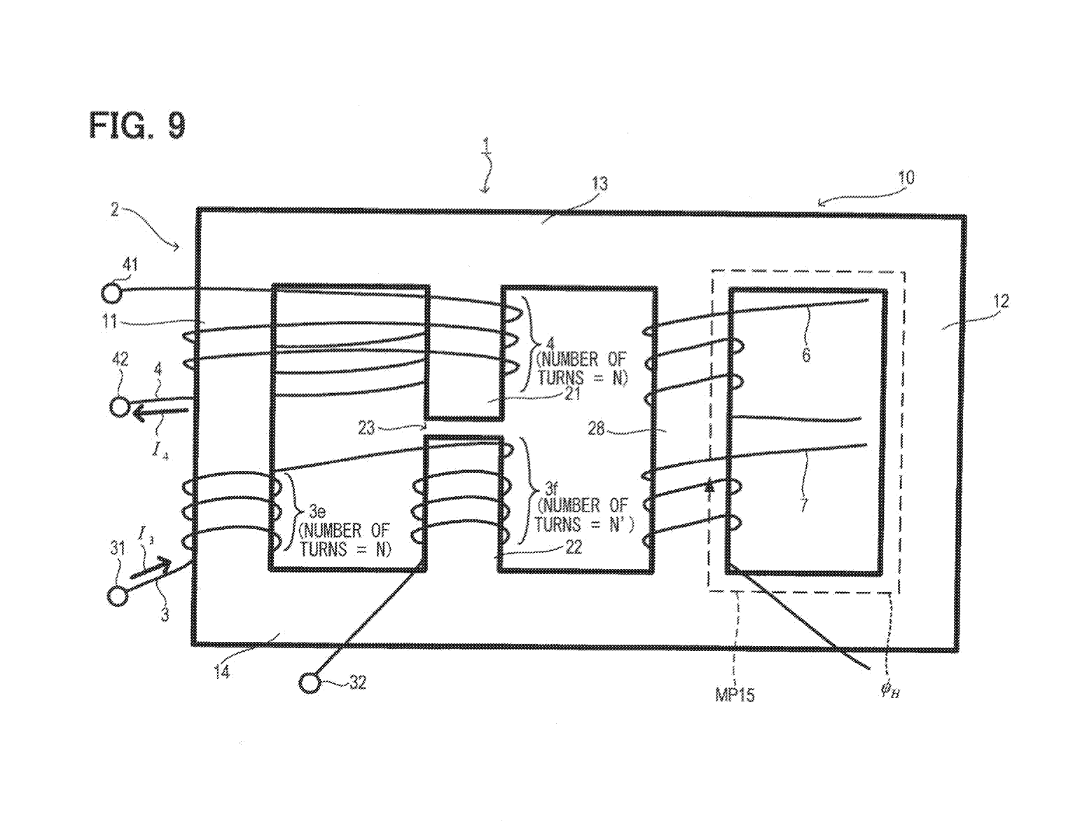

The filter component 1 of the sixth embodiment is provided with the magnetic core 2, the winding wires 3, 4, and winding wires 6 and 7 as shown in FIG. 9.

The magnetic core 2 includes the frame shape magnetic core member 10, the center members 21 and 22, and a center member 28.

The center member 28 projects perpendicularly from the upper core member 13 at a position between the right member 12 and the center members 21 and 22, toward an inside of the frame shape of the magnetic core member 10, which results in a bridging shape between the upper core member 13 and the lower core member 14.

The winding wires 6, 7 are wound around the center member 28. Further, a magnetic flux φ_{H} generated by the supply of the electric current to the winding wires 6, 7 forms a magnetic path MP15. The magnetic path MP15 is a closed magnetic circuit (i.e., a loop) which passes an inside of the core 2 through the center member 28, the right member 12, and the right parts of the upper core member 13 and the lower core member 14 relative to the member 28. That is, the magnetic path of the magnetic flux that is generated by the supply of the electric current to the winding wire 6 is interlinked with the winding wire 7, and the magnetic path of the magnetic flux that is generated by the supply of the electric current to the winding wire 7 is interlinked with the winding wire 6. Therefore, the winding wires 6, 7 together with the magnetic flux φ_{H} provide as a transformer function.

The magnetic flux in magnetic parts tends to flow into a path which has no winding wire wound thereon and has a lower magnetic reluctance preferentially. Therefore, the magnetic flux φ_{H} generated by the supply of the electric current to the winding wires 6, 7 passes the right member 12, instead of passing the center members 21 and 22 and the left member 11. Thus, an electromagnetic interference between the magnetic parts formed by the winding wires 6 and 7 and the magnetic parts formed by the winding wires 3 and 4 is prevented.

### Seventh Embodiment

The seventh embodiment of the present disclosure is described with reference to the drawings. The seventh embodiment focuses on a difference from the first embodiment.

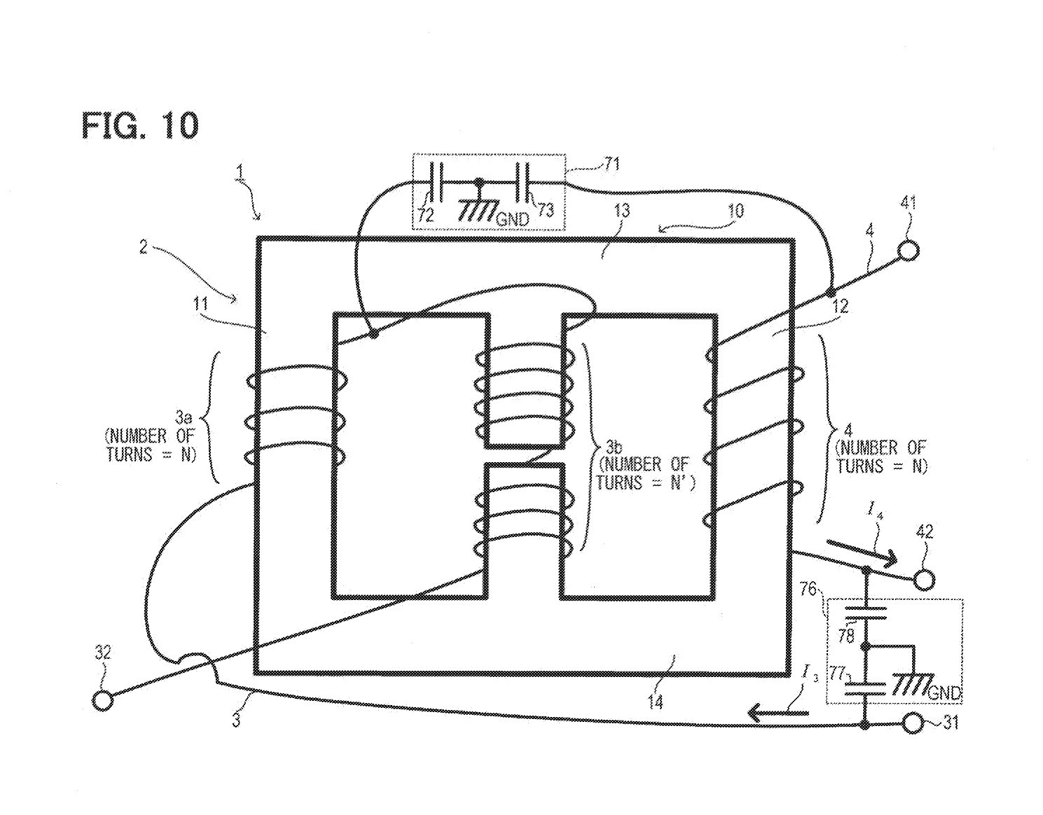

The filter component 1 of the seventh embodiment is provided with the magnetic core 2, the winding wires 3 and 4, and common mode noise rejection capacitor circuits 71 and 76 as shown in FIG. 10.

The common mode noise rejection capacitor circuit 71 is provided with a capacitor 72 and a capacitor 73. The capacitor 72 has one end connected to a point on an electric current path passing through the winding wire 3 from the winding wire 3a to the winding wire 3b, and has the other end connected to a ground GND. The capacitor 73 has one end connected to a point on an electric current path passing through the winding wire 4 from the one end 41 to a winding part that is wound around the right member 12.

The common mode noise rejection capacitor circuit 76 is provided with a capacitor 77 and a capacitor 78. The capacitor 77 has one end connected to a point on an electric current path passing through the winding wire 3 from the one end 31 to the winding wire 3a, and the other end connected to a ground GND. The capacitor 78 has one end connected to a point on an electric current path passing through the winding wire 4 from the one end 41 to a winding part that is wound around the right member 12.

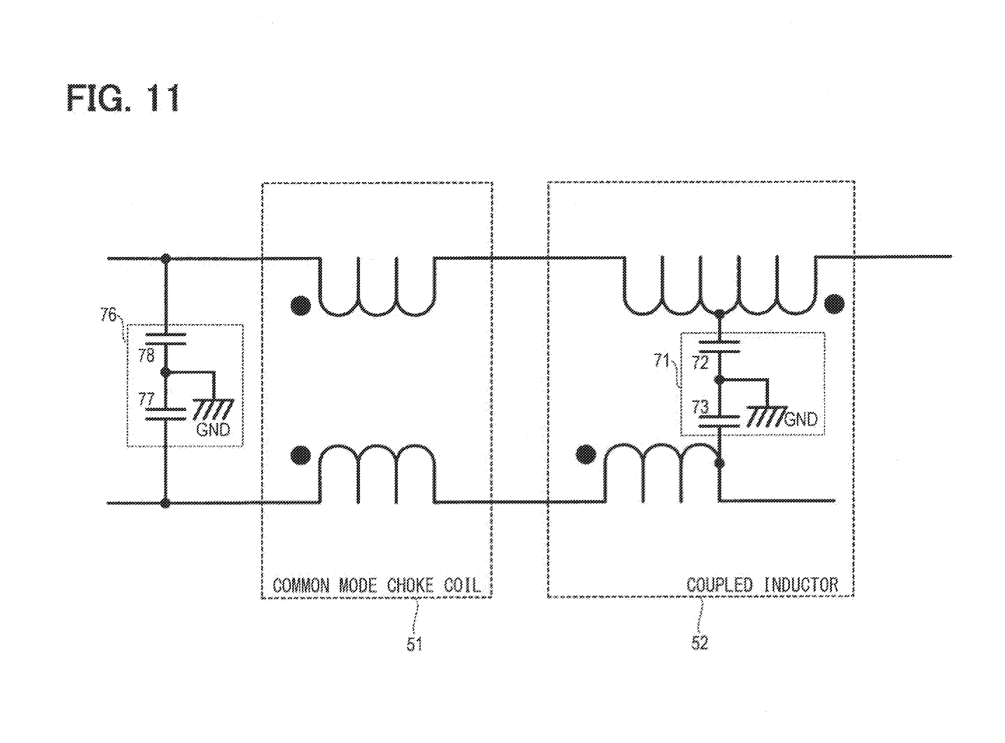

FIG. 11 is a diagram of an equivalent circuit of the filter component 1 in the seventh embodiment.

As shown in FIG. 11, the common mode noise rejection capacitor circuit 71 is connected to a middle point tap of the coupled inductor 52. Therefore, when a noise electric current flows into a path between the winding wire 3 and the winding wire 4 via the common mode noise rejection capacitor circuit 71, the coupled inductor 52 does not perform a reactor function for a frequency component which can be smoothed by a capacitor. If such operation is a problem, the capacitance of the capacitor assigned to the common mode noise rejection capacitor circuit 71 must be sufficiently small.

In the filter component 1 configured in the above-described manner, the winding wire 3a and the winding wire 4 have its one end or other end grounded via the capacitors 72, 73, 77 and 78 each of which has capacitive impedance. Thereby, the filter component 1 can flow the common mode noise electric current, which flows through the winding wire 3a and the winding wire 4 that serve as a common mode choke coil, to the ground GND via the capacitors 72, 73, 77 and 78, and thus can have an improved common mode noise damping capacity.

In the embodiment described above, the capacitors 72, 73, 77 and 78 are a noise rejection part of the present disclosure.

### Eighth Embodiment

The eighth embodiment of the present disclosure is described with reference to the drawings. The eighth embodiment focuses on a difference from the seventh embodiment.

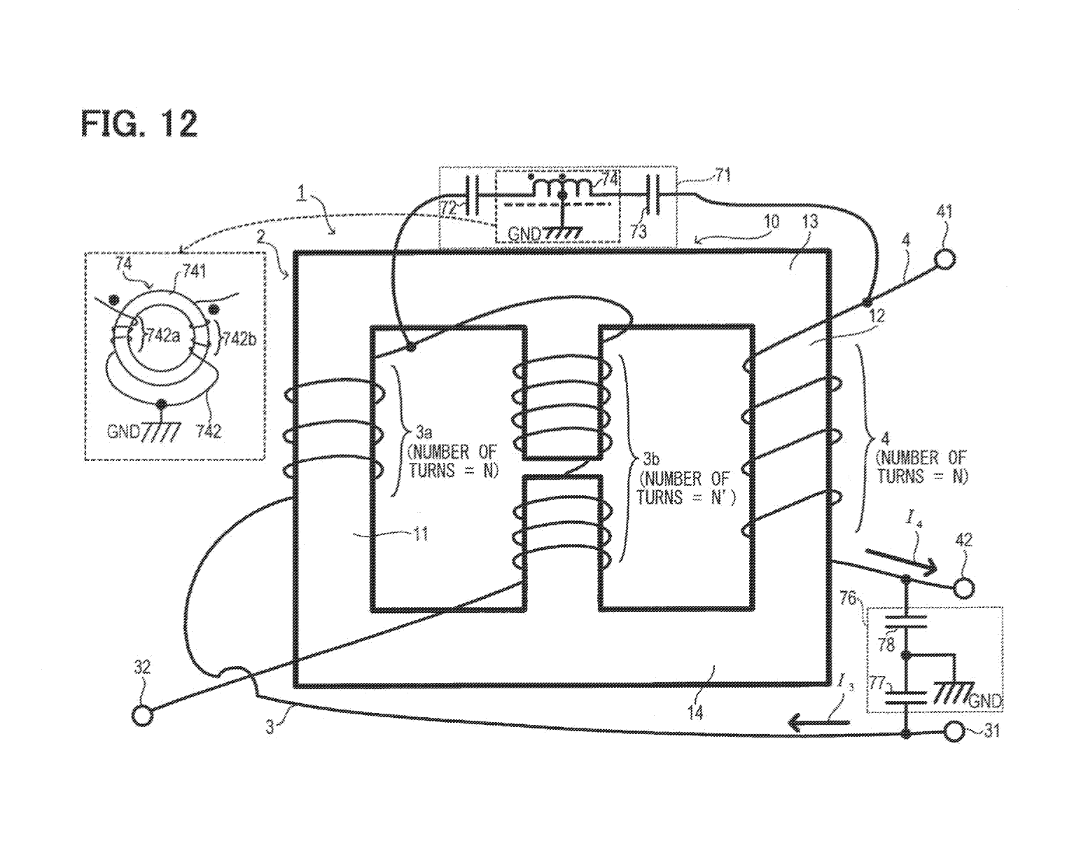

The filter component 1 of the eighth embodiment is the same as the one in the seventh embodiment except that a configuration of the common mode noise rejection capacitor circuit 71 is changed from the seventh embodiment, as shown in FIG. 12.

Further, the common mode noise rejection capacitor circuit 71 is the same as the one in the seventh embodiment except that a common mode choke coil 74 is added to the circuit 71.

The common mode choke coil 74 is formed as a winding wire 742 wound around a hollow cylinder-shape magnetic core 741, with one end of the wire 742 connected to a capacitor C1 and with the other end of the wire 742 connected to a capacitor C2. Thereby, the common mode choke coil 74 is connected in series with the capacitors 72 and 73 at a position between the capacitor 72 and the capacitor 73.

The winding wire 742 is grounded at a point somewhere between a start point and an end point of the wire 742 that is wound around the magnetic core 741. Therefore, a common mode choke coil L1 is formed as a combination of two in-series winding wires 742a and 742b, i.e., the wire 742a between the start point and a point connected to the ground GND and the wire 742b between the GND and the end point, respectively wound around the magnetic core 741.

Further, the winding wire 742a is so wound around the magnetic core 741 that, when the electric current flows from the capacitor 72 to the ground GND, the electric current flows through a hollow circle of the magnetic core 741 from a surface side of the magnetic core 741 toward a back side of the drawing in FIG. 12 (i.e., the electric current flowing from above a surface of a paper having FIG. 12 printed thereon toward a back of it).

Further the winding wire 742b is so wound around the magnetic core 741 that, when the electric current flows from the capacitor 73 to the ground GND, the electric current flows through the hollow circle of the magnetic core 741 from the back side of the magnetic core 741 toward the surface side of the drawing in FIG. 12.

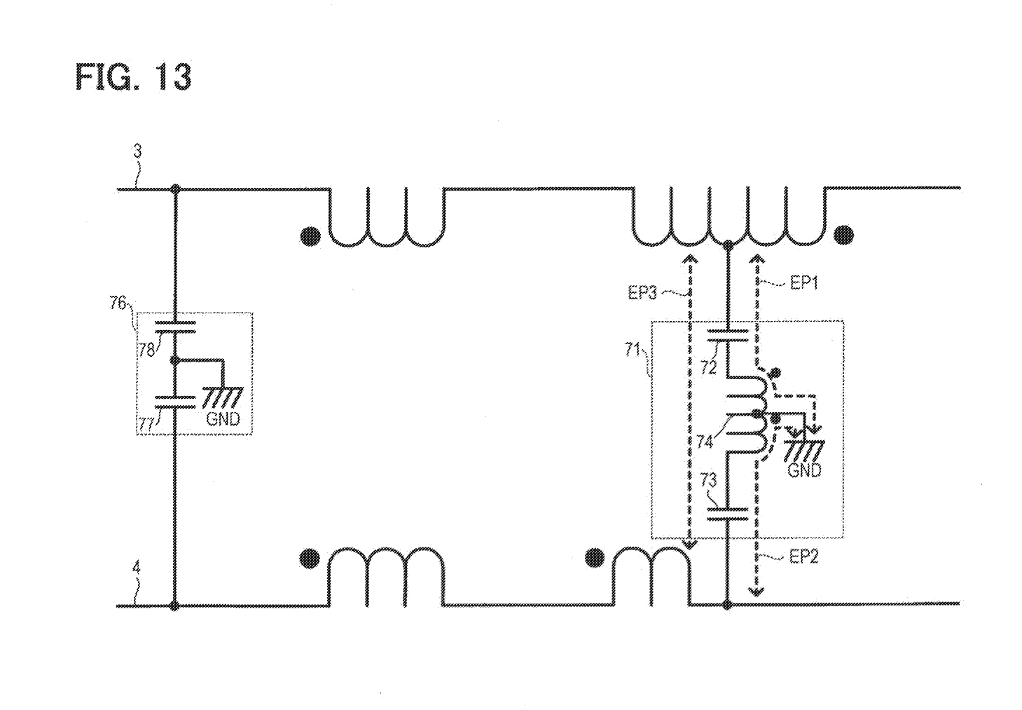

In such manner, as shown in FIG. 13, a flow of the electric current flowing to the ground GND is permitted through one of two electric current paths EP1 and EP2, i.e., the path EP1 from the winding wire 3 to the ground GND via the capacitor 72 and the common mode choke coil 74 and the path EP2 from the winding wire 4 to the ground GND via the capacitor 73 and the common mode choke coil 74. Further, a flow of the electric current through an electric current path EP3, which is from the winding wire 3 to the winding wire 4 via the capacitor 72, the common mode choke coil 74, and the capacitor 73, is blocked. Therefore, there is no noise electric current flowing between the winding wire 3 and the winding wire 4 via the common mode noise rejection capacitor circuit 71, and the coupled inductor 52 performs a reactor function for a frequency component which can be smoothed by a capacitor.

Thus, by an addition of the common mode choke coil 74, capacitance of the capacitor used in the common mode noise rejection capacitor circuit 71 can be increased, without spoiling the reactor function. In such case, the electric current flowing through the common mode noise rejection capacitor circuit 71 is sufficiently small in comparison to the electric current flowing through the filter component 1. Therefore, the volume of the common mode choke coil L1 id sufficiently reduced in comparison to the filter component 1.

In the embodiment described above, the capacitor 72 is a first noise rejection part of the present disclosure, the capacitor 73 is a second noise rejection part of the present disclosure, the electric current path EP1 is a first electric current path of the present disclosure, the electric current path EP2 is a second electric current path of the present disclosure, and the common mode choke coil 74 is an electric current blocking part in the present disclosure.

### Ninth Embodiment

The ninth embodiment of the present disclosure is described with reference to the drawings. The ninth embodiment focuses on a difference from the first embodiment.

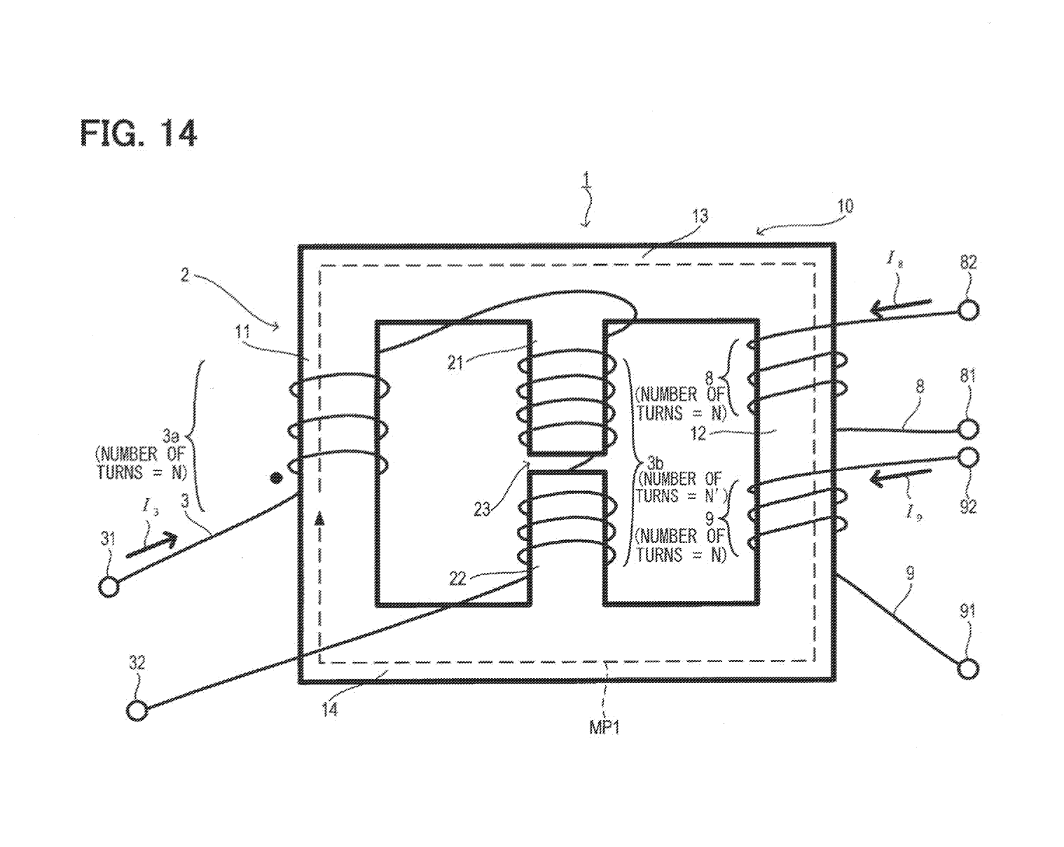

The filter component 1 of the ninth embodiment is provided with the magnetic core 2, the winding wire 3, and winding wires 8 and 9 as shown in FIG. 14.

The winding wire 8 is wound around the right member 12. The number of turns of the winding wire 8 on the right member 12 is equal to N. Further, the winding wire 8 is so wound around the right member 12 that, when an electric current I₈ flows from one end 82 to other end 81 of the winding wire 8 (see an arrow I₈ in FIG. 14), the electric current flows on the upper surface of the right member 12 from the right-hand side to the left-hand side.

The winding wire 9 is wound around the right member 12. The number of turns of the winding wire 9 on the right member 12 is equal to N. Further, the winding wire 9 is so wound around the right member 12 that, when an electric current I₉ flows from one end 92 to other end 91 of the winding wire 9 (see an arrow I₉ in FIG. 14), the electric current flows on the upper surface of the right member 12 from the right-hand side to the left-hand side.

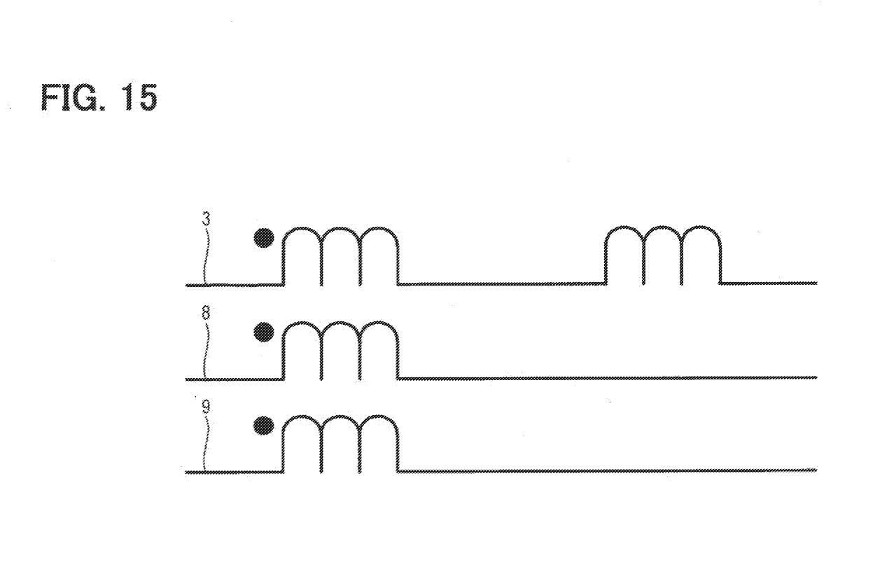

The three winding wires 3, 8, and 9 of the filter component 1 configured in the above-described manner are interlinked with the magnetic path MP1 that has a small magnetic reluctance, and, as shown in FIG. 15, it has/provides a function equivalent to a three-phase common mode choke coil.

In the present embodiment described above, the winding wire 3 is a first winding of the present disclosure, the winding wire 8 is a second winding of the present disclosure, and the winding wire 9 is a fifth winding of the present disclosure.

### Tenth Embodiment

The tenth embodiment of the present disclosure is described with reference to the drawings.

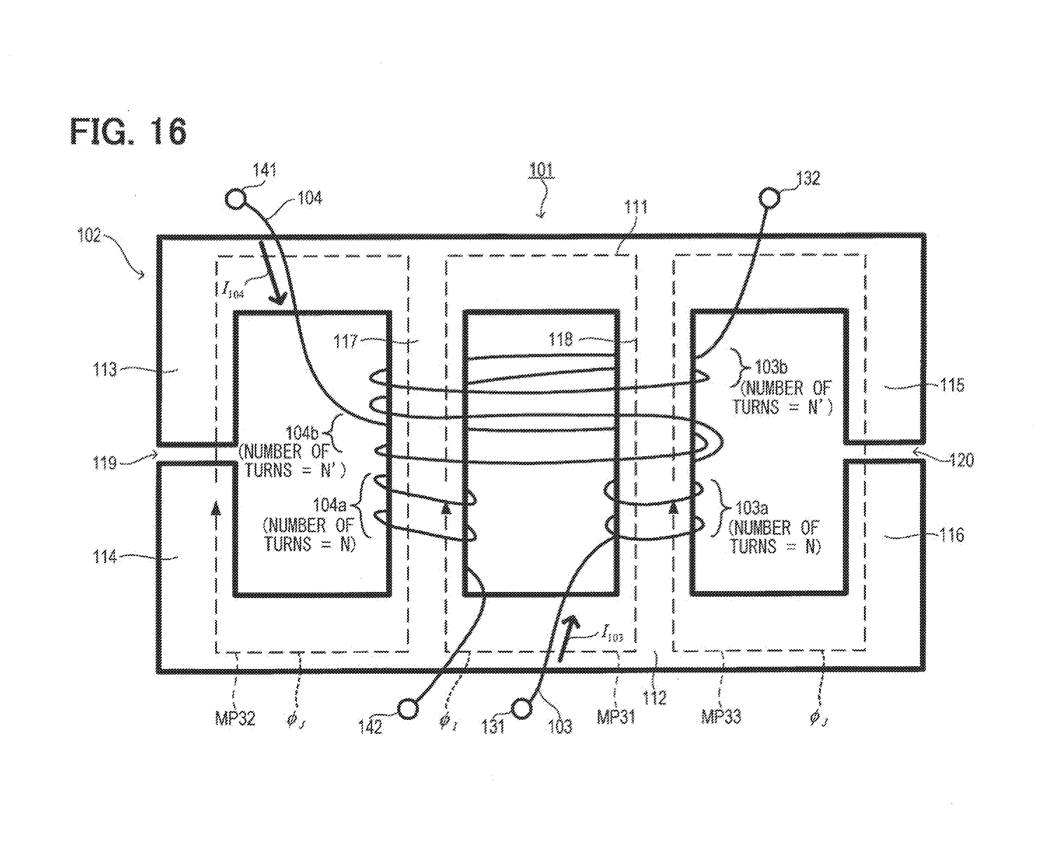

The filter component 101 of the present embodiment is provided with a magnetic core 102 and winding wires 103, 104 as shown in FIG. 16.

The magnetic core 102 is provided with an upper magnetic core member 111, a lower magnetic core member 112, outer leg magnetic core members 113, 114, 115, 116, and center members 117, 118.

The upper magnetic core member 111 and the lower magnetic core member 112 are the magnetic bodies formed in a long shape. Further, the upper magnetic core member 111 and the lower magnetic core member 112 are arranged in parallel with each other along their longitudinal direction.

The outer leg magnetic core member 113 projects perpendicularly from a left end of the upper magnetic core member 111 toward the lower magnetic core member 112, as shown in FIG. 16.

The outer leg magnetic core member 114 projects perpendicularly from a left end of the lower magnetic core member 112 toward the upper magnetic core member 111, as shown in FIG. 16. Further, the outer leg magnetic core member 114 faces the outer leg magnetic core member 113 with a predetermined amount of gap interposed therebetween. That is, a gap 119 is defined at a position between the outer leg magnetic core member 113 and the outer leg magnetic core member 114.

The outer leg magnetic core member 115 projects perpendicularly from a right end of the upper magnetic core member 111 toward the lower magnetic core member 112, as shown in FIG. 16.

The outer leg magnetic core member 116 projects perpendicularly from a right end of the lower magnetic core member 112 toward the upper magnetic core member 111, as shown in FIG. 16. Further, the outer leg magnetic core member 116 faces the outer leg magnetic core member 115 with a predetermined amount of gap interposed therebetween. That is, a gap 120 is defined at a position between the outer leg magnetic core member 115 and the outer leg magnetic core member 116.

The center member 117 projects perpendicularly from the upper magnetic core member 111 toward the lower magnetic core member 112, bridging the upper magnetic core member 111 and the lower magnetic core member 112 at a position between the outer leg magnetic core members 113, 114 and the outer leg magnetic core members 115,116.

The center member 118 projects perpendicularly from the upper magnetic core member 111 toward the lower magnetic core member 112, bridging the upper magnetic core member 111 and the lower magnetic core member 112 at a position between the center member 117 and the outer leg magnetic core members 115, 116.

The winding wire 103 is wound around the center member 118 (i.e., the number of turns around the member 118 is N), and is also wound around the center members 117, 118 so that both of the two members 117, 118 are circled in a loop of the wire 103 (i.e., the number of turns around the members 117, 118 is N′).

In the following, a part of the winding wire 103 wound around the center member 118 is designated as a winding wire 103a, and a part of the winding wire 103 wound around the center members 117, 118 is designated as a winding wire 103b.

The winding wire 103 is so wound that, when an electric current I₁₀₃ flows from one end 131 to other end 132 of the winding wire 103 (see an arrow I₁₀₃ in FIG. 16), the electric current flows first to the part that is wound around the center member 118, and then flows to the part that is wound around the two magnetic core members 117, 118.

Further, the winding wire 103 is so wound that, when the electric current I₁₀₃ flows from the one end 131 to the other end 132 of the winding wire 103, the electric current flows on the upper surface of the core 102 in FIG. 16 from the right-hand side to the left-hand side.

The winding wire 104 is wound in one loop around the center member 117 and the center member 118 (i.e., the number of turns is N′), and is wound around the center member 117 (i.e., the number of turns is N).

In the following, a part of the winding wire 104 wound around the center member 117 is designated as a winding wire 104a, and a part of the wire 104 wound around both of the center members 117,118 is designated as a winding wire 104b.

The winding wire 104 is so wound that, when an electric current I₁₀₄ flows from one end 141 to other end 142 of the winding wire 4 (see an arrow I₁₀₄ in FIG. 16), the electric current flows first to the part that is wound in one loop around the center members 117, 118, and then flows to the part that is wound around the center member 117.

Further, the winding wire 104 is so wound that, when the electric current I₁₀₄ flows from the one end 141 to the other end 142 of the winding wire 104, the electric current flows on the upper surface of the core 102 in FIG. 16 from the right-hand side to the left-hand side.

The filter component 101 is represented as a superposition/bundle of a magnetic flux φ_{I} and a magnetic flux φ_{J} which are mutually-independent.

The magnetic flux φ_{I} is generated by the supply of the electric current to the winding wires 103,104, and forms a magnetic path MP31. The magnetic path MP31 is a closed magnetic circuit (i.e., a loop) which passes an inside of the core 102 through the center members 117, 118 and a part of the upper magnetic core member 111 and a part of the lower magnetic core member 112 respectively positioned in between the two magnetic core members 117 and 118.

The magnetic flux φ_{I} is interlinked only with the winding wire 103a and the winding wire 104a. Further, since the magnetic path MP31 has no gap (i.e., a gap like the gap 119 or the gap 120 which is formed between the two outer leg magnetic core members 113, 114 or the two outer leg magnetic core members 115, 116), magnetic reluctance is small on the loop magnetic path (i.e., on the magnetic path MP31) of the magnetic flux φ_{I}.

Therefore, the magnetic flux φ_{I} and the winding wires 103a and 104a form a common mode choke coil.

The magnetic flux φ_{J} is generated by the supply of the electric current to the winding wires 103, 104, and forms magnetic paths MP32 and MP33.

The magnetic path MP32 is a closed loop of the magnetic path that passes an inside of the core 102 through the center member 117, the outer leg magnetic core members 113, 114, and left parts of the upper magnetic core member 111 and the lower magnetic core member 112 relative to the magnetic core member 117.

The magnetic path MP33 is a closed loop of the magnetic path which passes an inside of the core 102 through the center member 118, the outer leg magnetic core members 115, 116, and right parts of the upper magnetic core member 111 and the lower magnetic core member 112 relative to the magnetic core member 118.

The magnetic flux φ_{J} is interlinked only with the winding wire 103b, the winding wire 104a, and the winding wire 104b on the magnetic path MP32, and is interlinked only with the winding wire 103a, the winding wire 103b, and the winding wire 104b on the magnetic path MP33.

Further, since the magnetic paths MP32 and MP33 have the gaps 119, 120, magnetic reluctance is large on the loop magnetic path of the magnetic flux φ_{J} (i.e., on the magnetic paths MP32, MP33).

Therefore, the magnetic flux φ_{J} and the winding wires 103, 104 provide a reactor function.

In the embodiment described above, the winding wire 103a is a first winding of the present disclosure, the winding wire 104a is a second winding of the present disclosure, the winding wire 103b is a third winding of the present disclosure, the winding wire 104b is a fourth winding of the present disclosure, the core 102 is a magnetic core of the present disclosure, the magnetic path MP31 is a first magnetic path of the present disclosure, the magnetic path MP32 is a second magnetic path of the present disclosure, and the magnetic path MP33 is a third magnetic path of the present disclosure.

### Eleventh Embodiment

The eleventh embodiment of the present disclosure is described with reference to the drawings.

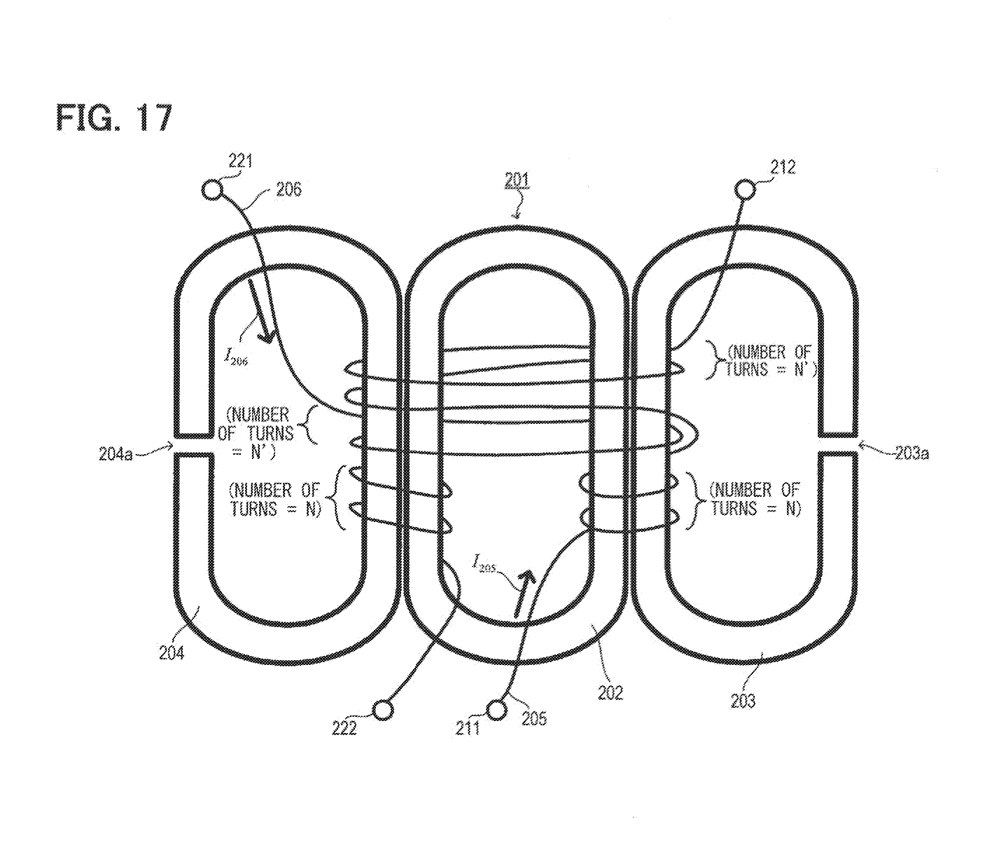

A filter component 201 of the present embodiment is provided with toroidal magnetic cores 202, 203, 204 and winding wires 205, 206 as shown in FIG. 17.

The toroidal magnetic cores 202, 203, 204 are a magnetic body formed in a shape of a hollow cylinder. However, the toroidal magnetic cores 203, 204 have a gap 203a or a 204a on one part of it.

Further, the toroidal magnetic cores 203, 204 are arranged to have the toroidal magnetic core 202 interposed therebetween.

The winding wire 205 is wound around and interlinked with the toroidal magnetic cores 202, 203 (i.e., the number of turns around the cores 202, 203 is N), and is wound around and interlinked with the toroidal magnetic cores 203, 204 (i.e., the number of turns around the cores 203, 204 is N′).

The winding wire 205 is so wound that, when the electric current flows from one end 211 towards other end 212 of the winding wire 205 (see an arrow I₂₀₅ in FIG. 17), the electric current flows first to a part of the wire 205 that is wound around the toroidal magnetic cores 202, 203 and then flows to a part that is wound around the toroidal magnetic cores 203, 204.

Further, the winding wire 205 is so wound that, when the electric current I₂₀₅ flows from the one end 211 to the other end 212 of the winding wire 205, the electric current flows on the upper surface of the toroidal magnetic cores 202, 203, 204 in FIG. 17 from the right-hand side to the left-hand side.

The winding wire 206 is wound around and interlinked with the toroidal magnetic cores 203, 204 (i.e., the number of turns around the cores 203, 204 is N′), and is wound around and interlinked with the toroidal magnetic cores 202, 204 (i.e., the number of turns around the cores 202, 204 is N).

The winding wire 206 is so wound that, when the electric current flows from one end 221 towards other end 222 of the winding wire 206 (see an arrow I₂₀₆ in FIG. 17), the electric current flows first to a part that is wound around the toroidal magnetic cores 203, 204, and then flows to a part that is wound around the toroidal magnetic cores 202, 204.

Further, the winding wire 206 is so wound that, when the electric current I₂₀₆ flows from the one end 221 to the other end 222 of the winding wire 206, the electric current flows on the upper surface of the toroidal magnetic cores 202, 203, 204 in FIG. 17 from the right-hand side to the other end 222.

The filter component 201 configured in the above-described manner corresponds to the filter component 101 of the tenth embodiment, in which the magnetic core 102 is replaced with the toroidal magnetic cores 202, 203, 204. That is, the magnetic paths flowing in an inside of the toroidal magnetic cores 202, 203, 204 in a loop shape are respectively equivalent to the magnetic paths MP31, MP32, and MP33 of the filter component 101.

Therefore, the filter component 201 has an equivalent function to the filter component 101 of the tenth embodiment.

In the present embodiment described above, the winding wire 205 is a first winding and a third winding of the present disclosure, the winding wire 206 is a second winding and a fourth winding of the present disclosure, and the toroidal magnetic cores 202, 203, 204 are a magnetic core of the present disclosure.

(Example of Applications of the Filter Component 1)

In the following, the example of applications of the filter component of the present embodiment is described with reference to the drawings.

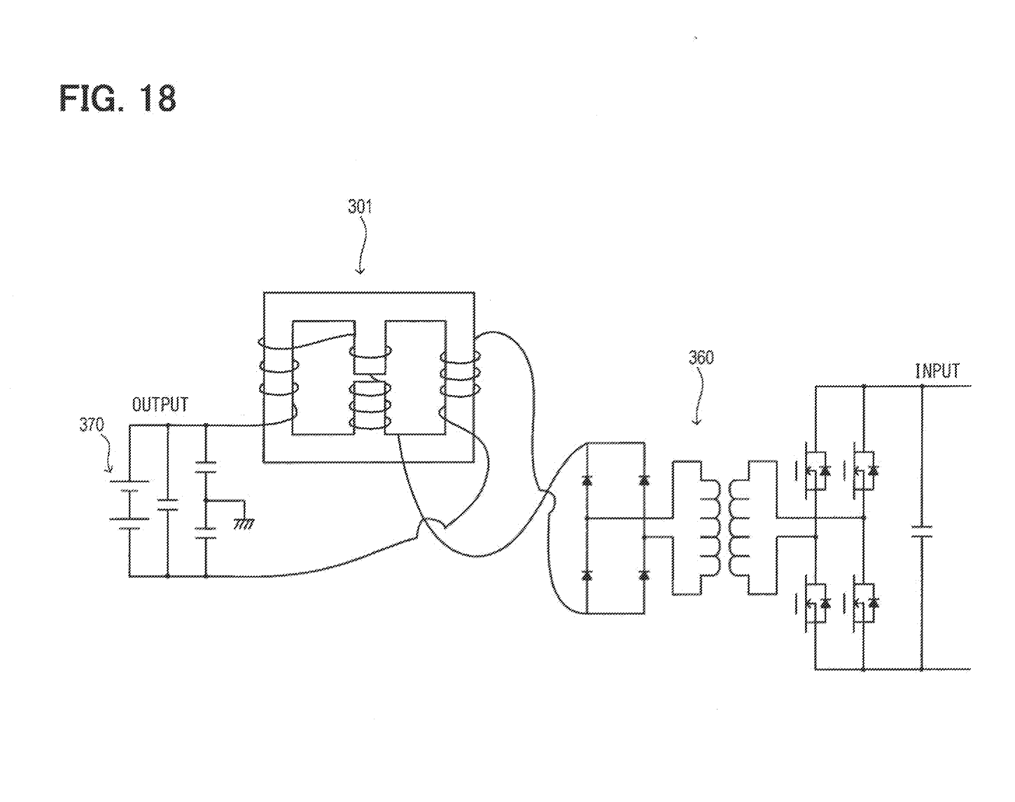

As shown in FIG. 18, a filter component 301 which has/provides a reactor function and a common mode choke coil function may be disposed on an electric current path between an in-vehicle battery charge circuit (i.e., an insulation converter) 360 and a battery 370.

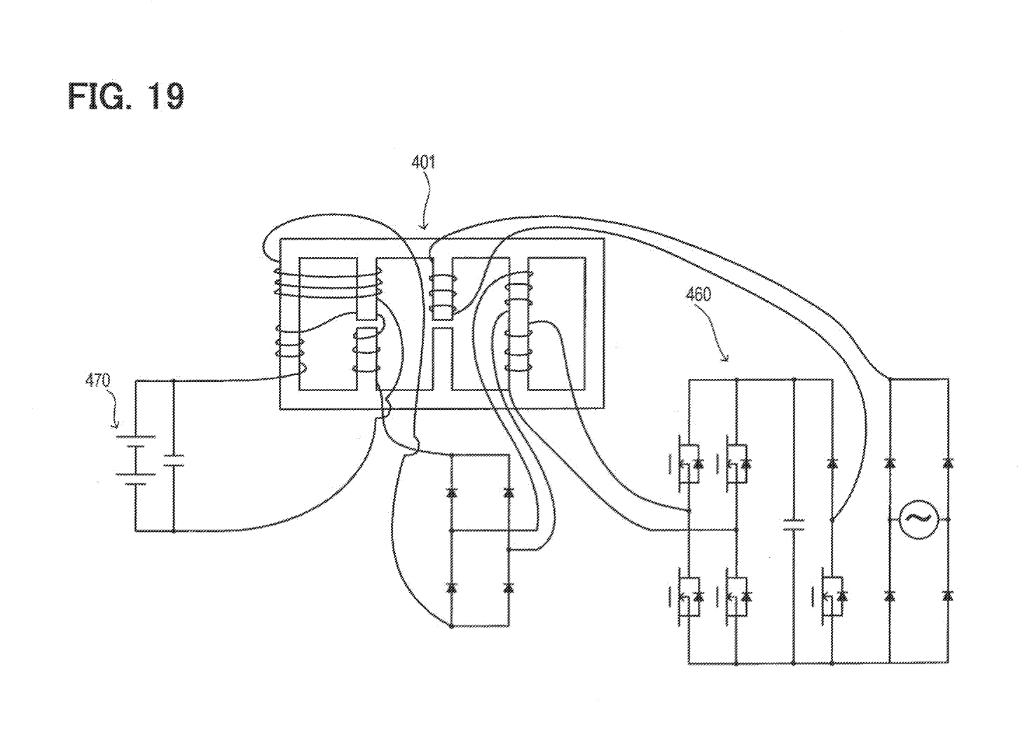

Further, as shown in FIG. 19, a filter component 401 which has a reactor function, a common mode choke coil function, and an isolation transformer function may be disposed on an electric current path between an in-vehicle battery charge circuit (i.e., a PFC converter) 460 and a battery 470.

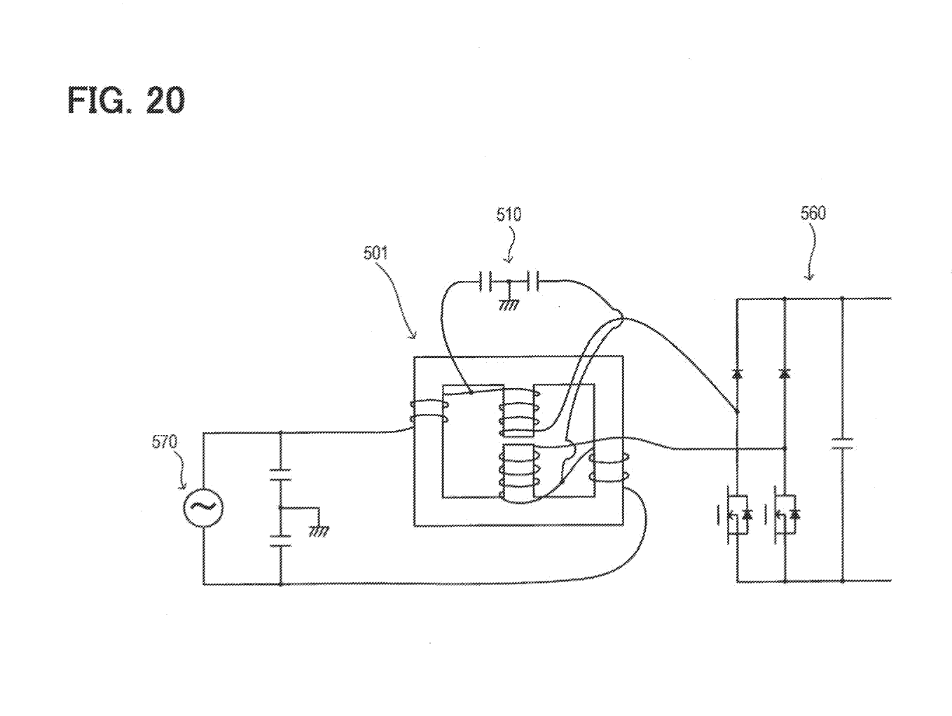

Further, as shown in FIG. 20, a filter component 501 which has/provides a reactor function and a common mode choke coil function and to which a common mode noise rejection capacitor circuit 510 is connected may be disposed on an electric current path between a bridge-less PFC circuit 560 and a commercial power supply 570.

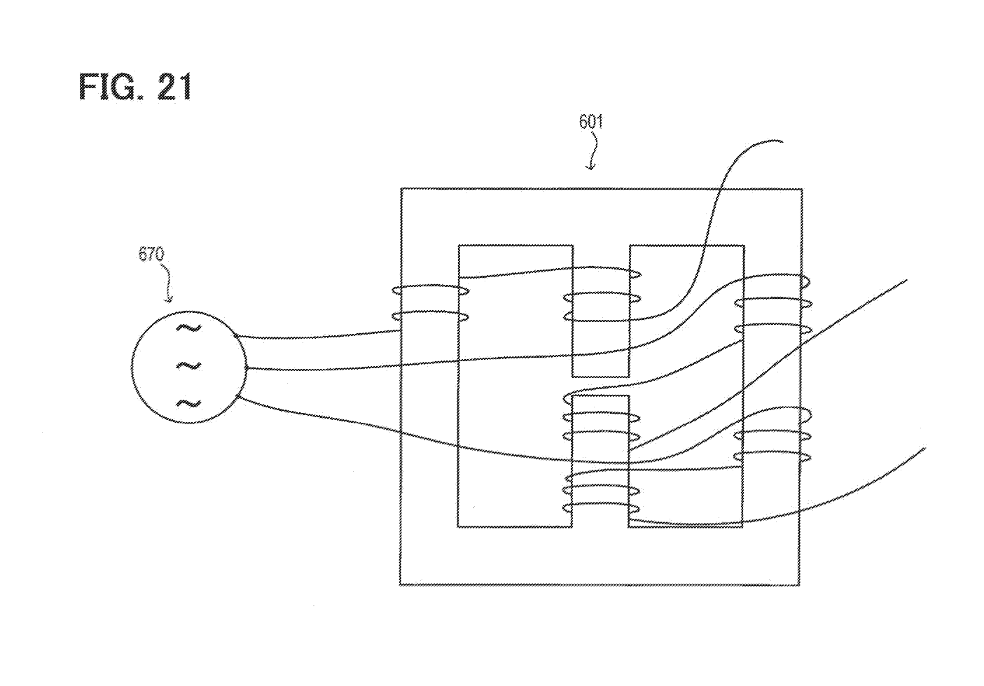

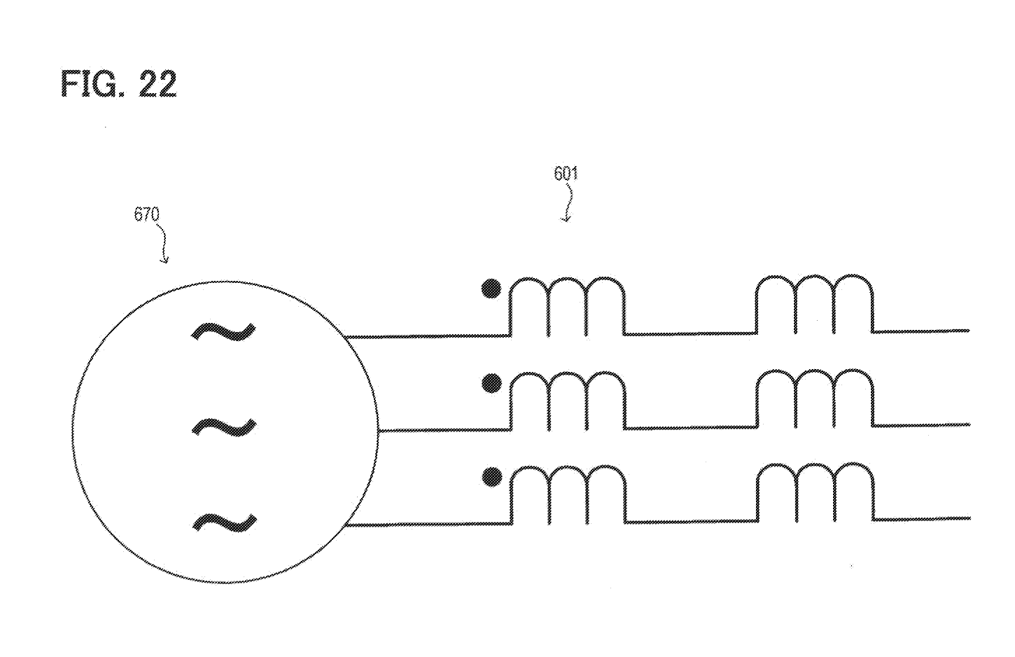

Further, as shown in FIGS. 21 and 22, a filter component 601 which has of a reactor function and a common mode choke coil function may be used as a filter of a three-phase power source 670.

Although the present disclosure has been fully described in connection with preferred embodiment thereof with reference to the accompanying drawings, it is to be noted that various changes and modifications will become apparent to those skilled in the art, and such changes, modifications, and summarized scheme are to be understood as being within the scope of the present disclosure as defined by appended claims.

What is claimed is:

1. A filter component comprising:
a first winding wire;
a second winding wire providing electric current to the first winding wire from a separate supply of electric current;
a third winding wire connected in series with the first winding wire; and
a magnetic core having the first winding wire, the second winding wire, and the third winding wire wound around the magnetic core, and having a magnetic path of a magnetic flux that is caused by the electric current supplied to the first, second, and third winding wires formed in the magnetic core, wherein
a magnetic core shape provides, in an inside of the core, a first magnetic path which is a loop of the magnetic flux interlinked with the first winding wire and the second winding wire and not interlinked with the third winding wire, and a second magnetic path which is a loop of the magnetic flux interlinked with the first winding wire and the third winding wire and not interlinked with the second winding wire,
a winding direction of the first winding wire on the magnetic core and a winding direction of the second winding wire on the magnetic core are configured such that an electric current flow direction in the first winding wire is opposite to an electric current flow direction in the second winding wire at an opening of the magnetic core, which is surrounded by the first magnetic path when the supply of the electric current flows from the first winding wire to the second winding wire, and
the winding direction of the first winding wire on the magnetic core and a winding direction of the third winding wire on the magnetic core are configured such that an electric current flow direction in the first winding wire is the same as an electric current flow direction in the third winding wire at the opening of the magnetic core, which is surrounded by the second magnetic path when the supply of the electric current flows to both of the first winding wire and the third winding wire that are connected in series.

2. The filter component of claim 1, wherein
the magnetic core shape has, in an inside of the core, a formation of a third magnetic path which is a loop of the magnetic flux interlinked with the second winding wire and the third winding wire interlink and not interlinked with the first winding wire, and
the winding direction of the second winding wire on the magnetic core and the winding direction of the third winding wire on the magnetic core are configured such that electric current flow directions in both of the second winding wire and the third winding wire are the same direction at the opening of the magnetic core which is surrounded by the third magnetic path.

3. The filter component of claim 2, further comprising:
a fourth winding wire connected in series with the second winding wire, wherein
the fourth winding wire is interlinked with the third magnetic path, and
the winding direction of the second winding wire on the magnetic core and a winding direction of the fourth winding wire on the magnetic core are configured such that electric current flow directions in both of the second winding wire and the fourth winding wire are the same direction at the opening of the magnetic core, which is surrounded by the third magnetic path, when the supply of the electric current flows to both of the second winding wire and the fourth winding wire.

4. The filter component of claim 1, wherein
the number of turns of the first winding wire interlinked with the first magnetic path is the same as the number of turns of the second winding wire interlinked with the first the magnetic path.

5. The filter component of claim 1, wherein
magnetic reluctance of the second magnetic path is greater than magnetic reluctance of the first magnetic path.

6. The filter component of claim 1, wherein
the magnetic core includes a first magnetic core part containing all parts of the magnetic core on which the first, second, and third winding wires are wound around, or a second magnetic core part that has no winding wire wound thereon, and
the second magnetic core part is arranged in circles around all peripheries of the first magnetic core part except for at least one section of the first magnetic core part.

7. The filter component of claim 1, wherein
the first winding wire and the second winding wire have at least one of a one end or an other end that is connected to a ground via a first noise rejection part that is formed by an element or a circuit which has a capacitive impedance.

8. The filter component of claim 7, wherein
one of the one end and or the other end of the first winding wire, through which the third winding wire is connected, is connected to the ground via the first noise rejection part that is formed by the element or the circuit which has the capacitive impedance,
the one end of the second winding wire is connected to the ground via a second noise rejection part that is formed by the element or the circuit which has the capacitive impedance, and
based on a first electric current path and a second electric current path, the first electric current path defined as extending from the first winding wire to the ground via the first noise rejection part and the second electric current path defined as extending from the second winding wire to the ground via the second noise rejection part, an electric current blocking part is provided as an element that (i) allows an electric current flowing through one of the first electric current path and the second electric current path to the ground and (ii) prevents an electric current flowing from the first winding wire to the second winding wire, starting from a point between the first winding wire and the third winding wire to the one end of the second winding wire through both of the first and second electric current paths.

9. The filter component of claim 1, wherein
the magnetic core includes
a first core member on which the first winding wire is wound and formed in a first shape in which one end and an other end of the first core member are arranged along a direction of the magnetic flux generated by the supply of the electric current to the first winding wire,
a second core member on which the second winding wire is wound and formed in a second shape in which one end and an other end of the second core member are arranged along a direction of the magnetic flux generated by the supply of the electric current to the second winding wire,
a third core member on which the third winding wire is wound and formed in a third shape in which one end and an other end of the third core member are arranged along a direction of the magnetic flux generated by the supply of the electric current to the third winding wire,
a first connecting member connected to the one end of the first core member, the one end of the second core member, and the one end of the third core member, and
a second connecting member connected to the other end of the first core member, the other end of the second core member, and the other end of the third core member.

10. The filter component of claim 3, wherein
the magnetic core includes
a first core member on which the first winding wire is wound and formed in a shape in which one end and an other end of the first core member are arranged along a direction of the magnetic flux generated by the supply of the electric current to the first winding wire,
a second core member on which the second winding wire is wound and formed in a shape in which one end and an other end of the second core member are arranged along a direction of the magnetic flux generated by the supply of the electric current to the second winding wire,
a fourth winding member on which the third winding wire and the fourth winding wire are wound and formed in a shape in which one end and an other end of the fourth winding member are arranged along a direction of the magnetic flux generated by the supply of the electric current to the third and fourth winding wires,
a third connecting member connected to the one end of the first core member, the one end of the second core member, and the one end of the fourth winding member, and
a fourth connecting member connected to the other end of the first core member, the other end of the second core member, and the other end of the fourth winding member.

11. The filter component of claim 1, further comprising:
a fifth winding wire providing electric current to the first and second winding wires from the separate supply of electric current, wherein
the fifth winding wire is wound around the magnetic core to be interlinked with the first magnetic path.
